(19) United States
(12) Patent Application Publication
(10) Pub. No.: US 2026/0008907 A1
(43) Pub. Date: Jan. 8, 2026

(54) HIERARCHICALLY STRUCTURED POLYMER COMPOSITE WITH HALLOYSITE NANOTUBES AND GLASS FIBERS

(71) Applicant: AXIOM GROUP INC., Aurora (CA)

(72) Inventors: Patrick Chang Dong LEE, Etobicoke (CA); Rafaela ANTUNES COSTA AGUIAR, Toronto (CA); Nello David SANSONE, Richmond Hil (CA); Anthony TUCCITTO, Toronto (CA); Matthew LEROUX, Aurora (CA); Iman SOLTANI, Richmond Hill (CA)

(21) Appl. No.: 19/066,361

(22) Filed: Feb. 28, 2025

Related U.S. Application Data
(60) Provisional application No. 63/668,549, filed on Jul. 8, 2024.

(51) Int. Cl. C08K 7/14; C08J 5/04; C08K 3/34; C08K 7/10; C08K 9/02; C08K 9/06; C08L 23/12

(52) U.S. Cl. CPC C08K 7/14; C08J 5/043; C08K 3/346; C08K 7/10; C08K 9/02; C08K 9/06; C08L 23/12; C08J 2323/12; C08K 2201/011; C08L 2203/20

(57) ABSTRACT

A polymer composite provides enhanced mechanical strength, thermal stability, and multifunctionality. The polymer composite includes fibrous assemblies, each comprising a glass fiber with halloysite nanotubes deposited thereon. A polymer matrix surrounds the fibrous assemblies and forms trans-crystalline structures. The glass fibers may be modified with an aminosilane coupling agent to induce a positive electrostatic charge, while the halloysite nanotubes have a negative electrostatic charge, enabling electrostatic adhesion. The trans-crystalline structures may include B-crystals, and the fibrous assemblies may be substantially aligned in the polymer composite. These features improve processability and durability. The composite is suitable for enclosures of electric vehicle components and other structural applications requiring lightweight, high-performance materials.

### CROSS-REFERENCE TO RELATED APPLICATION

This application claims the benefit of U.S. Provisional Patent Application No. 63/668,549, entitled “Tailoring Synergistic Multifunctionality in Lightweight Bio-inspired Cylindrical Core-Shell Hybrid Composites”, filed Jul. 8, 2024, the entire contents of which are incorporated herein by reference.

### FIELD

The present specification is directed to polymer composite materials, and in particular to fiber-reinforced polymer composites.

### BACKGROUND

Fiber-reinforced polymer composites, such as glass fiber-reinforced polypropylene and carbon fiber-reinforced polymers, offer high strength and low weight but often lack thermal stability and insulation, limiting their use in automotive and aerospace applications. Weight reduction is critical in these industries, yet achieving a balance of strength, toughness, thermal stability, and insulation remains a challenge. There is a need for lightweight, multifunctional polymer composites that integrate these properties without compromising processability.

### SUMMARY

The specification provides a polymer composite that integrates halloysite nanotubes (HNTs) and glass fibers (GFs) in a polymer matrix, forming trans-crystalline structures that enhance load transfer, fiber orientation, and adhesion. This results in superior mechanical properties, including an 84% increase in impact strength and a 20% weight reduction, while improving thermal stability, flame retardancy, and processability. The polymer composite enables glass fiber reduction without compromising strength and supports sustainable manufacturing by reducing material redundancies. It is suitable for vehicle components such as engine covers, storage containers, and exterior panels, as well as other structural applications.

An aspect of the specification provides a polymer composite including a plurality of fibrous assemblies. Each fibrous assembly includes a glass fiber with aminosilane surface modification and a plurality of halloysite nanotubes deposited on the glass fiber. A polypropylene matrix surrounds the fibrous assemblies and forms trans-crystalline structures. The glass fibers comprise about 10% to 50% by weight of the polymer composite, and the halloysite nanotubes comprise 0.5±0.25% by weight of the polymer composite.

A further aspect of the specification provides a polymer composite including a plurality of fibrous assemblies. Each fibrous assembly includes a glass fiber with a plurality of halloysite nanotubes deposited on its surface. A polypropylene matrix surrounds the fibrous assemblies and forms trans-crystalline structures.

In one example, the glass fibers are modified to induce a positive electrostatic charge, and the fibrous assemblies are assembled by electrostatic adhesion between the positive electrostatic charge of the glass fibers and the negative electrostatic charge of the halloysite nanotubes.

In another example, the glass fibers are modified by silanization.

In a further example, the glass fibers are modified with an aminosilane coupling agent.

In another example, the glass fibers comprise about 10% to about 60% by weight of the polymer composite.

In a further example, the glass fibers comprise about 10% to about 50% by weight of the polymer composite.

In another example, the glass fibers comprise about 10% to about 30% by weight of the polymer composite.

In a further example, the glass fibers comprise about 20% to about 30% by weight of the polymer composite.

In another example, the halloysite nanotubes comprise about 0.25% to about 3% by weight of the polymer composite.

In a further example, the halloysite nanotubes comprise 0.5±0.25% by weight of the polymer composite.

In another example, the halloysite nanotubes comprise 0.5±0.1% by weight of the polymer composite.

In a further example, the halloysite nanotubes comprise 0.5±0.025% by weight of the polymer composite.

In another example, the trans-crystalline structures include β-crystals.

In a further example, the fibrous assemblies are substantially aligned.

A further aspect of the specification provides a polymer composite including a plurality of fibrous assemblies. Each fibrous assembly includes a glass fiber with aminosilane surface modification and a plurality of halloysite nanotubes deposited on the glass fiber. A polymer matrix surrounds the fibrous assemblies and forms trans-crystalline structures, the polymer matrix including a semi-crystalline polymer. The glass fibers comprise about 10% to 50% by weight of the polymer composite, and the halloysite nanotubes comprise 0.5±0.25% by weight of the polymer composite.

In one example, the polymer matrix includes polyamide.

A further aspect of the specification provides an enclosure for an electrical component of a vehicle including any of the above-described polymer composites.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Embodiments are described with reference to the following figures.

FIG. 1 is a schematic diagram of an osteon.

FIG. 2 is a schematic diagram of the polymer composite, according to one embodiment.

FIG. 3 is a diagram of a method of manufacturing the polymer composite, according to one embodiment.

FIG. 4A is a scanning electron microscope with energy-dispersive X-ray spectroscopy (SEM-EDS) image of the polymer composite, according to one embodiment.

FIG. 4B is another SEM-EDS of the polymer composite of FIG. 4A.

FIG. 4C is another SEM-EDS of the polymer composite of FIG. 4A.

FIG. 4D is another SEM-EDS of the polymer composite of FIG. 4A.

FIG. 5A is a thermogram showing the differential scanning calorimetry (DSC crystallization) behavior of the polymer composite.

FIG. 5B is a thermogram showing the DSC second heating behavior for the polymer composite.

FIG. 6 is an x-ray diffraction (XRD) diffractogram of the polymer composite.

FIG. 7 is a graph showing B-crystal formation as a function of reinforcement concentration in the polymer composite.

FIG. 8 is a graph showing the dependence of the Johnson-Mehl-Avrami-Kolmogorov Model (JMAK) exponent n on the temperature of isothermal crystallization in the polymer composite.

FIG. 9 is a series of images showing the variations in crystalline microstructure of a biphasic composite (PPGF40) with respect to time.

FIG. 10 is a series of images showing the variations in crystalline microstructure of the polymer composite (PPGF40HNT0.5) with respect to time.

FIG. 11 is a schematic diagram showing the micro-CT slicing direction, according to one example.

FIG. 12 is a graph showing the Hermans Orientation Factor of the polymer composite.

FIG. 13 is a graph showing the degree of orientation (DO) of the glass fibers in the polymer composite.

FIG. 14A is a micro-CT image of the biphasic composite comprising polypropylene and glass fibers.

FIG. 14B is a micro-CT image of the polymer composite.

FIG. 15 is a graph comparing shear viscosity to shear rate for the polymer composite.

FIG. 16 is a is a graph comparing shear viscosities to the reinforcement concentration of the halloysite nanotubes (HNTs) in the polymer composite.

FIG. 17 is a graph comparing the melt flow index (MFI) to the reinforcement concentration of the HNTs in the polymer composite.

FIG. 18 is a graph comparing the engineering tensile stress to the engineering tensile strain in the polymer composite.

FIG. 19A is a graph comparing the tensile strength to the reinforcement concentration of the HNTs in the polymer composite.

FIG. 19B is a graph comparing the tensile toughness to the reinforcement concentration of the HNTs in the polymer composite.

FIG. 20A is a graph comparing the flexural strength to the reinforcement concentration of the HNTs in the polymer composite.

FIG. 20B is a graph comparing the impact strength to the reinforcement concentration of the HNTs in the polymer composite.

FIG. 21 is a graph comparing the specific tensile modulus to the specific tensile strength for the polymer composite.

FIG. 22A is a graph comparing the thermal conductivity to the reinforcement concentration of the HNTs in the polymer composite.

FIG. 22B is a graph comparing the temperature difference and degree of orientation (DO) to the reinforcement concentration of the HNTs in the polymer composite.

FIG. 23 is a graph showing the rate of heat dissipation for the polymer composite.

FIG. 24 is a thermal image for a biphasic composite (PPGF60).

FIG. 25 is a thermal image for the polymer composite.

FIG. 26 is a graph showing thermal decomposition profiles for the polymer composite.

FIG. 27A is a graph showing T_{5%} and T_{10%} with respect to the reinforcement concentration of the HNTs in the polymer composite.

FIG. 27B is a graph showing the flame propagation speed and degree of orientation (DO) with respect to the reinforcement concentration of the HNTs in the polymer composite.

FIG. 28 is a graph of the zeta potential for HNTs, un-sized glass fibers, and sized glass fibers.

FIG. 29 is a graph showing the XPS spectra of the sized glass fibers.

FIG. 30 is a scanning electron microscope (SEM) image of HNTs deposited on glass fibers.

FIG. 31 is a SEM-EDS image for a biphasic PP/GF composite and the polymer composite.

FIG. 32 is a SEM-EDS image for a biphasic PP/GF composite and the polymer composite.

FIG. 33 is an SEM image of the biphasic PP/GF composite and an SEM image of the polymer composite.

FIG. 34 is a schematic diagram of the biphasic PP/GF composite (A) and nano-indentation Eᵣ mapping for the biphasic composite (B-D), a schematic diagram of the polymer composite (E), and nano-indentation Eᵣ mapping for the polymer composite (F-H).

FIG. 35 is a tomography image for the biphasic PP/GF composite and the polymer composite.

FIG. 36A is a graph of the tensile modulus with respect to the reinforcement concentration of the HNTs in the polymer composite.

FIG. 36B is a graph of the flexural modulus with respect to the reinforcement concentration of the HNTs in the polymer composite.

FIG. 36C is a graph of the synergistic effect with respect to the reinforcement concentration of the HNTs in the polymer composite.

FIG. 36D is a graph of the synergistic effect with respect to the reinforcement concentration of the HNTs in the polymer composite.

FIG. 37A is a perspective view of a battery casing for an electric vehicle, comprising the polymer composite.

FIG. 37B is another perspective view of the battery casing of FIG. 37A.

FIG. 38 is a chart showing the multifunctionality of the polymer composite in comparison to a biphasic PP/GF composite.

### DETAILED DESCRIPTION

### Table of Abbreviations

The following abbreviations are used herein:

| | |
|---|---|
| GF | glass fiber |
| DO | degree of fiber orientation |
| DSC | differential scanning calorimetry |
| EDS | energy-dispersive X-ray spectroscopy |
| FSC | fast scanning calorimetry |
| GnP | graphene nanoplatelets |
| HNT | halloysite nanotubes |
| JMAK | Johnson-Mehl-Avrami-Kolmogorov |
| MFI | melt flow index |
| micro-CT | micro-computed tomography |
| POM | polarized optical microscopy |
| PP | polypropylene |
| SEM | scanning electron microscopy |
| SPM | scanning probe microscopy |
| TGA | thermogravimetric analysis |
| XRD | X-ray diffraction analysis |
| XPS | X-ray Photoelectron Spectroscopy |

### Definitions

The following definitions are used herein:

“About” herein refers to a range of ±20% of the numerical value that follows. In one embodiment, the term “about” refers to a range of ±10% of the numerical value that follows. In one embodiment, the term “about” refers to a range of ±5% of the numerical value that follows.

“Composite” herein refers to a substance comprising two or more constituents.

“Glass fiber” (or “GF”) herein refers to a substance comprising fibers of glass.

“Halloysite nanotube” (or “HNT”) herein refers to a two-layered aluminosilicate with a general chemical formula Al₂Si₂O₅ (OH)₄·(nH₂O), and a hollow tubular structure in the sub-micrometer range. Halloysite nanotubes naturally occur in halloysite nanoclay (or “kaolin clay”).

“Polypropylene” (or “PP”) herein refers to a polymer formed from the monomer propene (also known as “propylene”) and having the general chemical formula (C₃H₆)ₙ.

### Polymer Composite

The present disclosure provides a polymer composite having improved mechanical properties, thermal stability, and insulation.

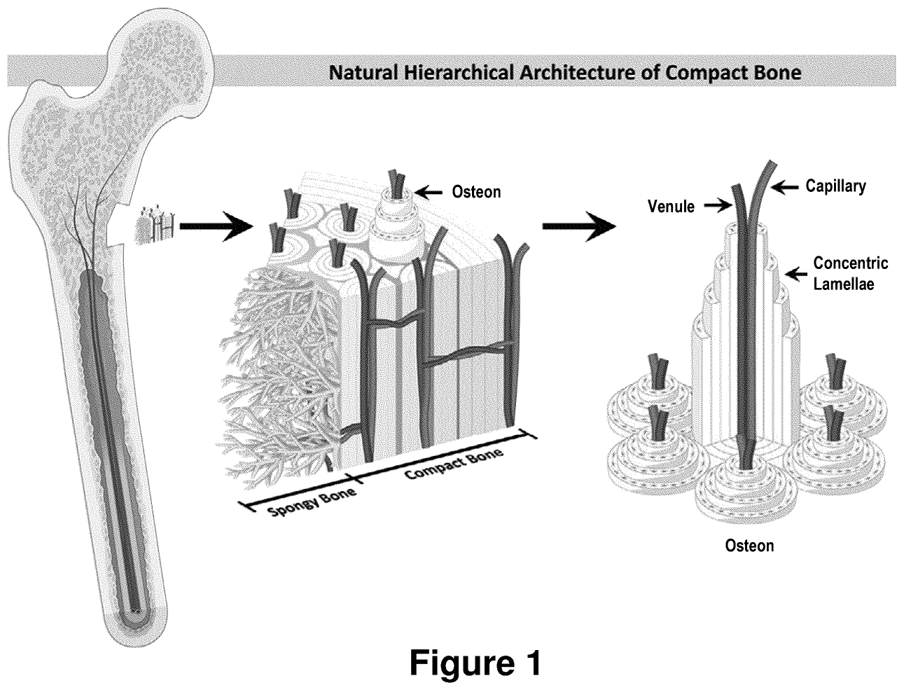

The structure of the polymer composite is analogous to osteons in compact bone, which consist of carbonate-substituted hydroxyapatite (dahllite), collagen fibrils, and proteins, forming ≈100 μm tubular structures, as shown in FIG. 1. While dahllite alone has a flexural strength of 14 MPa and a fracture toughness of 0.14 MPa·m^{1/2}, hierarchical assembly enhances these properties to 191.1 MPa and 7.33 MPa·m^{1/2}, respectively. A similar cylindrical core-shell structure is found in bamboo, where concentric fibril layers adapt to various load-bearing modes.

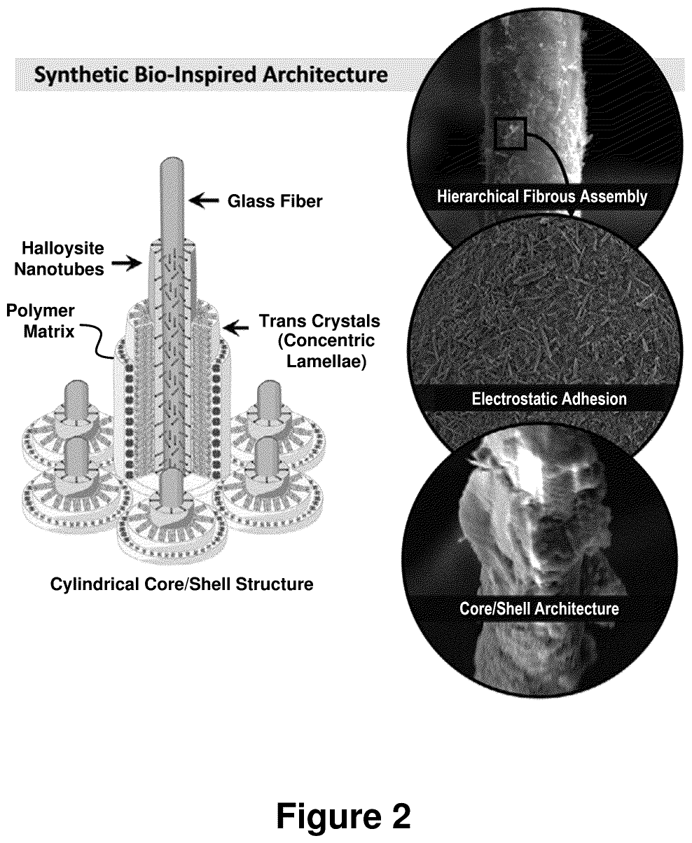

FIG. 2 is a schematic diagram of the polymer composite, according to one example. The polymer composite includes a plurality of fibrous assemblies (referred to collectively herein as “the fibrous assemblies”, and generically as “the fibrous assembly”), each fibrous assembly comprising a plurality of halloysite nanotubes (HNTs) deposited on a glass fiber (GF). The polymer matrix forms trans-crystalline structures around the fibrous assemblies.

In the examples described herein, the polymer matrix is generally described as a polypropylene (PP) matrix, however other suitable polymers are contemplated including but not limited to polyethylene, polyamide, polyester, styrene acrylic, vinyl-acrylic, polyvinyl alcohol, polyolefins, polyurethane, polyvinylchloride (PVC), polystyrene, epoxy resin, phenoxy, vinyl ester, acrylate, polycarbonate, polyacetal, polybutylene terephthalate (PBT), acrylonitrile butadiene styrene (ABS), polyphenylene sulfide (PPS), polylactic acid, polyhydroxyalkanoate (PHA), polybutylene adipate terephthalate (PBAT), polyoxymethylene (POM), polyethylene terephthalate (PET), poly (methyl methacrylate), thermoplastic elastomers, and combinations including blends, copolymers, and terepolymers thereof.

In preferred embodiments, the polymer matrix comprises a semi-crystalline polymer such as polypropylene, polyamide, polyethylene, polyolefins, polyoxymethylene (POM), polyphenylene sulfide (PPS), polyetheretherketone (PEE), or polyphthalamide.

The polymer composite has a concentric, cylindrical core-shell architecture. In the concentric, cylindrical core-shell architecture, the fibrous assembly of glass fibers with halloysite nanotubes deposited thereupon comprises a cylindrical core, and the trans-crystals comprise a shell concentrically surrounding the cylindrical core at the interface of the fibrous assemblies and the polymer matrix.

In some embodiments, the glass fibers include silicon dioxide, but the glass fibers are not particularly limited. In other examples, the glass fibers include alumina, calcium oxide, boron oxide, magnesium oxide, zirconium oxide, and combinations thereof.

Prior to mixing with the polymer matrix and halloysite nanotubes, the glass fibers may have an average length between 1±0.05 mm and 20±1 mm, but the length is not specifically limited. In specific embodiments, the glass fibers have an average length between 5±0.25 mm and 15±0.75 mm, advantageously between 8±0.4 mm and 12±0.6 mm, and more advantageously 10±0.5 mm. In some examples, the glass fibers have an average diameter between 4±0.2 μm. and 34±1.7 μm, but the diameter is not specifically limited. In specific embodiments, the glass fibers have an average diameter between 10±0.5 μm to 20±1 μm, advantageously between 15±0.75 μm and 25±1.2 μm, and more advantageously 20±1 μm. During the injection molding process, some glass fibers are mechanically fragmented by shear forces, compression and bending, fiber-fiber impact, and viscous resistance. Consequently, the fiber lengths of the molded polymer composite may exhibit reduced fiber lengths, with shorter glass fibers measuring less than 1 mm, while the average fiber length remains between 3±0.15 mm and 5±0.25 mm.

In some examples, particularly examples wherein the polymer matrix comprises a nylon matrix, the average length of the glass fibers may be less than 1 mm.

The halloysite nanotubes may have an average length between 50 and 5000 nm, but the length is not specifically limited. In specific embodiments, the halloysite nanotubes have an average length between 500±25 nm and 6000±300 nm, but the average length is not particularly limited. The halloysite nanotubes may have an average external diameter between 10±0.5 nm and 100±5 nm, but external diameter is not particularly limited. In other examples, the halloysite nanotubes have an average external diameter between 30±1.5 nm and 70±3.5 nm. The halloysite nanotubes may have an average surface area between 60±3 m²/g and 70±3.5 m²/g, but the average surface area is not particularly limited. In particular examples, the average surface area is 64 m²/g. The halloysite nanotubes may have a true specific gravity between 2.14 g/cm³ and 2.53 g/cm³, but the specific gravity is not particularly limited. In particular examples, the specific gravity is 2.53 g/cm³. A specific, non-limiting example of the halloysite nanotube is halloysite nanoclay, catalogue #685445 (Sigma Aldrich: Massachusetts, USA) having a general chemical formula of Al₂Si₂O₅(OH)₄·2 H₂O. In addition to improving the mechanical properties of the fibrous assembly, there are several advantages to the halloysite nanotubes. The halloysite nanotubes are environmentally friendly, naturally occurring tubular aluminosilicates with large lumen volumes, high aspect ratios, low cost, high abundance, and exhibit great dispersibility in the polypropylene matrix.

The fibrous assembly of the glass fibers and the halloysite nanotubes may be assembled by electrostatic adhesion. Opposing electrostatic charges on the glass fibers and the halloysite nanotubes may cause the fibrous assembly to self-assemble.

To improve electrostatic adhesion with the halloysite nanotubes, the glass fibers may be functionalized or otherwise modified. In specific non-limiting examples, the glass fibers are modified by silanization such that silane groups are deposited on the outer surface of the glass fibers. The glass fibers may be pre-treated with a silane agent such that at least one silane group is covalently bonded to the surface of at least one of the glass fibers. Typically, silane agents bind to a hydroxyl group on the outer surface of a glass fiber. Silane groups may include Si—O—Si, Si—OCH₃, NH₂-silane, or Si—OR, but the silane groups are not particularly limited. Generally, the binding of the silane groups to the glass fibers functionalizes the glass fibers, increasing the affinity of the glass fibers to the halloysite nanotubes. Glass fibers that are pre-treated with a silane agent may be referred to herein as “silanized” glass fibers. In particular embodiments described herein, the glass fibers are treated with an aminosilane coupling agent to induce aminosilane surface modification, generating a positive electrostatic charge of about ±34 eV.

The halloysite nanotubes are deposited on the glass fibers, and in some examples, the halloysite nanotubes encapsulate the glass fibers. The halloysite nanotubes may be attached to an external surface of the glass fibers by electrostatic adhesion.

Halloysite nanotubes (HNTs) naturally contain aluminum (Al(III)) and silicon (Si(IV)) cations within their aluminosilicate structure. While these cations are positively charged, the overall surface charge of HNTs is negative due to the presence of oxygen-containing groups on the basal surface. This intrinsic negative electrostatic charge of approximately −37 eV enables electrostatic adhesion to positively-charged glass fibers without requiring any modification. The naturally occurring charge distribution of HNTs facilitates strong interactions with the glass fibers, contributing to enhanced composite performance.

The fibrous assemblies may be substantially aligned within the polymer composite. In particular, the fibrous assemblies may be more aligned in comparison to biphasic composites comprising only polypropylene and glass fibers. It is thought that the halloysite nanotubes promote the disentanglement of glass fibers, resulting in improved alignment of the fibrous assemblies, which in turn improves tensile strength and stiffness.

While the glass fibers alone provide some reinforcement to the polymer composite, the fibrous assembly of glass fibers and halloysite nanotubes significantly improves mechanical properties of the polymer composite, similar to the synergistic effect of dahllite and collagen fibrils in osteons.

The polypropylene matrix comprises a homopolymer or a copolymer. The polypropylene may have a melt flow rate of about 4 to about 70 g/10 min. In specific embodiments, the polypropylene has a melt flow rate of 30±2 g/10 min to 70±2 g/10 min and advantageously 50±2 g/10 min to 70±2 g/10 min. In its granular form, the polypropylene may have a specific gravity between 0.895 g/cm³ and 0.94 g/cm³. In specific embodiments, the polypropylene has a specific gravity between 0.90 g/cm³ and 0.91 g/cm³ and advantageously 0.902±0.04 g/cm³.

A specific, non-limiting example of the polypropylene is HIVAL® 2435 Neat PP, with a melt flow rate of 35±2 g/10 min (230° C./2.16 kg) and a specific gravity of 0.902±0.04 g/cm³ (Nexeo Plastics: The Woodlands, United States). The polypropylene and glass fibers may be provided as GF-filled PP pellets. A specific, non-limiting example of a GF-filled PP pellet is KompoGTe® LE1G60 (Kolon Industries: Daegu, South Korea).

The halloysite nanotubes promote crystalline growth in the polypropylene matrix. The polypropylene matrix forms a trans-crystalline structure around the fibrous assembly, and in some examples, the trans-crystalline structure encapsulates the fibrous assembly. Instead of forming the spherulitic α-crystals, the trans-crystalline structure may predominantly comprise β-crystals which are superior in mechanical properties as compared to α-crystals.

The polymer composite may further include one or more additives including but not limited to colorants, pigments, antistatic agents, foaming agents, water, surfactants, dispersants, anti-foam agents, antioxidants, thermal stabilizers, light or ultraviolet (UV) stabilizers, light or UV absorbing additives, microwave absorbing additives, reinforcing fibers, conductive fibers or particles, lubricants, process aids, fire retardants, anti-blocking additives, crystallization or nucleation agents, or a combination thereof.

The halloysite nanotubes compose between about 0.1% and about 5% by weight of the polymer composite. In specific embodiments, the halloysite nanotubes compose between about 0.25% and about 0.75% by weight of the polymer composite. In a preferred embodiment, the halloysite nanotubes compose between 0.25±0.01% and 1±0.2% by weight of the polymer composite, advantageously 0.5±0.25% by weight of the polymer composite, more advantageously, 0.5±0.1% by weight of the polymer composite, and even more advantageously 0.5±0.025% by weight of the polymer composite. Generally, the maximum β-nucleation occurs when the composition of halloysite nanotubes is 0.5±0.25% by weight. In compositions comprising ≥0.75% halloysite nanotubes, the halloysite nanotubes are increasingly likely to agglomerate, reducing the nucleation efficiency.

The glass fibers compose between about 10% and about 60% by weight of the polymer composite. In specific non-limiting embodiments, the glass fibers compose between about 20% and about 60% by weight of the polymer composite. In further non-limiting embodiments, the glass fibers compose between about 40% and about 60% by weight of the polymer composite. In a preferred embodiment, the glass fibers compose between 35±2% and 45±2% by weight of the polymer composite, advantageously 40±2% by weight of the polymer composite, and more advantageously 39.5±2% by weight of the polymer composite.

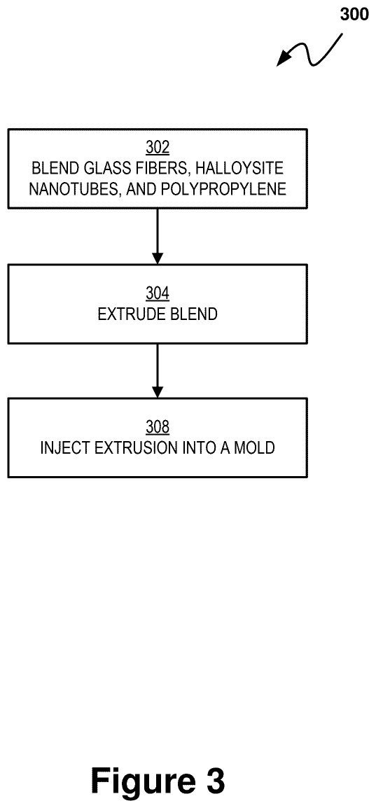

FIG. 3 is a diagram of a method 300 for manufacturing a polymer composite.

At block 302, glass fibers, halloysite nanotubes, and polypropylene are blended together. A variety of blending techniques are contemplated, including but not limited to dry blending and melt mixing. In preferred embodiments, the blending at block 302 is a dry blending technique.

As part of block 302, the halloysite nanotubes may be prepared for blending by vacuum-drying to remove interlamellar-bound water. In particular examples, the halloysite nanotubes are dried under vacuum for 24 hours at 110° C.

In some examples, the glass fibers, halloysite nanotubes, and polypropylene are blended in a single blending step, however the method 300 is not particularly limited, and in other examples, the blending occurs in multiple stages. The order of blending the constituents is not particularly limited. In examples where the blending occurs in multiple stages, each blending stage may include the same or different blending techniques. In one example, PP-HNT pellets are prepared by blending the polypropylene with the halloysite nanotubes prior to the performance of block 302. In this example, block 302 includes blending the PP-HNT pellets with the glass fibers. In another example, PP-GF pellets are prepared by blending and extruding the polypropylene with the glass fibers prior to the performance of block 302. In this example, block 302 includes blending the PP-GF pellets with the halloysite nanotubes. When PP-GF pellets or PP-HNT pellets or a combination of PP-GF pellets and PP-HNT pellets are used, block 302 may further include diluting the blend with additional polypropylene to achieve the desired composition.

At block 304, the blend comprising the glass fibers, halloysite nanotubes, and polypropylene is extruded. Block 304 is performed by an extruder. A non-limiting example of an extruder is a Leistritz® twin-screw extruder (27 mm, L/D: 40)(Leistritz: Nuremberg, Germany). The melt extrusion temperature may be selected according to the polymer matrix. Generally, the melt extrusion temperature is between 100±5° C. to 350±18° C. In a specific embodiment, the extrusion process is conducted with a screw speed of 45±2 rpm and a temperature profile of 140±7° C. (feeding) to 190±10° C. (die).

Block 308 comprises injecting the extrusion into a mold. The injection molding at block 212 is performed by an injection molding machine.

In some examples, block 304 may be omitted, and block 308 comprises injecting the blend from block 202 directly into a mold using an injection molding machine that both heats and mixes the blend. In embodiments where the blend is extruded, block 308 is performed on the extrusion obtained at block 304. A non-limiting example of an injection molding machine is a 50-ton Allrounder™ 270/320C injection molding machine (Arburg: Lossburg, Germany) with a 30 mm diameter screw. In certain other non-limiting examples, the injection molding machine is equipped with MuCell® Technology (Trexel Inc., Woburn, Massachusetts).

The mold temperature may be selected according to the polypropylene matrix. Generally, the mold temperature is between 40±2° C. and 180±9° C. In a specific embodiment, the injection is conducted at a mold temperature of 80±4° C.

Reducing the mold temperature may decrease the molding processing cycle time. In one non-limiting example, the mold temperature is 80° C. and the injection molding processing time is 123 seconds. In another non-limiting example, the mold temperature is 65° C. and the injection molding processing time is 93 seconds. While the shorter processing cycle may sacrifice crystallization degree in the small articles, for a large article (such as a battery encasement), the cooling time is sufficiently high to allow appropriate crystallization to happen and to improve the properties of the final article. As such, reducing the mold temperature can decrease the overall time and cost of manufacturing an article.

The mold may be shaped to form pellets comprising the polymer composite or to form an article. In examples where the mold is shaped to form pellets, the pellets may be sized and shaped to be used in subsequent injection molding to form an article. In examples where the mold is shaped to form an article, the article is not particularly limited. Examples articles include but are not limited to automotive parts, aerospace parts, packaging, construction materials, and electronics. In specific examples, mold is shaped to form a component for a vehicle such as an automotive vehicle or an aerospace vehicle. In particular examples, the mold is shaped to form an enclosure for an electrical component of a vehicle, and even more particularly an encasement for a battery.

In one non-limiting example, the polymer composite comprises about 39.5% by weight glass fibers and about 0.5% HNT by weight. At block 308, the blend is injected into an ASTM testing mold, with a mold temperature of 80° C. The resulting article may have a tensile strength of 149.21±3.71 MPa, a Young's Modulus of 8.70±0.26 GPa, a flexural strength of 182.71±3.30 MPa, a flexural modulus of 8.27±0.39 GPa, and an Izod impact of 71.11±1.84 kj/m².

In another non-limiting example, the polymer composite comprises about 39.5% by weight glass fibers and about 0.5% HNT by weight. At block 308, the blend is first injected into pellets comprising the polymer composite. The pellets are further injection molded into a battery tub (LT) mold with a mold temperature of 65° C. and a cycle time of 93 seconds. The resulting article may have a tensile strength of 143.66±4.40 MPa, a flexural modulus of 6.05±0.15 GPa, a flexural toughness of 3.99±0.36 MPa, a weight of 1.39 Kg, an Izod impact of 97.17±4.41 kj/m². Since the glass fibers are twice compounded in this example, there is increased glass fiber fragmentation and less dispersion resulting in reduced strength as compared to products that are directly injection molded into their final form.

It will now be apparent to a person of skill in the art that the present specification affords certain advantages over the prior art. For example, the polymer composite described herein exhibits a new crystalline phase, alongside the formation of a trans-crystalline phase that facilitates load-transfer at the fiber/matrix interface. As revealed by nanomechanical mapping, the formation of a stiffer interphase within the polymer composite, due to the cylindrical core-shell architecture, facilitates uniform load distribution. The degree of fiber orientation (DO) increased in the polymer composite, relative to the current industrial standard. This was ascribed to melt lubrication induced by HNT, confirmed through viscoelastic measurements.

The polymer composite surpasses the mechanical properties of the current industrial standard for automotive structural components, exhibiting improvements of 84%, 27%, 56%, and 30% in impact strength, specific tensile strength, tensile toughness, and specific flexural strength respectively, while providing a 20% weight reduction, and a 255% increase in melt flow index (MFI). Beyond mechanical performance, thermal management performance (insulating properties/thermal stability) is also improved, as well as retardation in flame propagation. The polymer composite is a multifunctional material with utility beyond mechanical performance. In the context of sustainable manufacturing, this assembly strategy is low-cost, industry-scale-ready, and can circumvent material redundancies in larger systems, producing lightweight, multifunctional hybrid composites.

Furthermore, the polymer composite comprising halloysite nanotubes (HNTs) and glass fibers (GFs) offers significant advantages in manufacturing, particularly in automotive applications. Glass fibers composites are commonly used in automative applications, but the glass fibers leave visible white streaks due to exposed fibers in the molded product. While reducing glass fiber content can minimize streaking, there is a trade-off with mechanical strength. In the polymer composite described herein, HNTs provide reinforcement, enabling a reduction in glass fiber content without sacrificing the required strength. Moreover, the electrostatic adhesion between the halloysite nanotubes and the glass fibers is typically unaffected by the addition of pigments. Therefore, the polymer composite can be colored, without compromising its hierarchical structure, unlike composites that are reinforced with other additives such as graphene nanoplatelets. This makes the polymer composite particularly useful for structural components that are visible to consumers, such as seat components (e.g., under-seat venting), battery boxes, engine covers, front trunks (frunks), storage containers, wheel garnishes and fender molding, underbody panels, and other exterior vehicle components. The ability to balance mechanical performance, aesthetics, and weight reduction makes this composite highly advantageous for automotive applications.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### EXAMPLES

The polymer composite will now be described with respect to the examples herein. In the examples, compositions of various embodiments are denoted by indicating the polymer matrix, the amount of halloysite nanotubes (HNTs) by weight and the amount of glass fiber (GF) by weight. By way of example, PPHNT0.5GF40 denotes an embodiment in which the polymer composite comprises 0.5% HNT by weight and 40% glass fibers by weight. The remainder of the weight, although not specified, comprises the polypropylene matrix.

### 1 Results & Discussion

### 1.1 Preparation and Characterization of Bio-Inspired Hybrid Composites

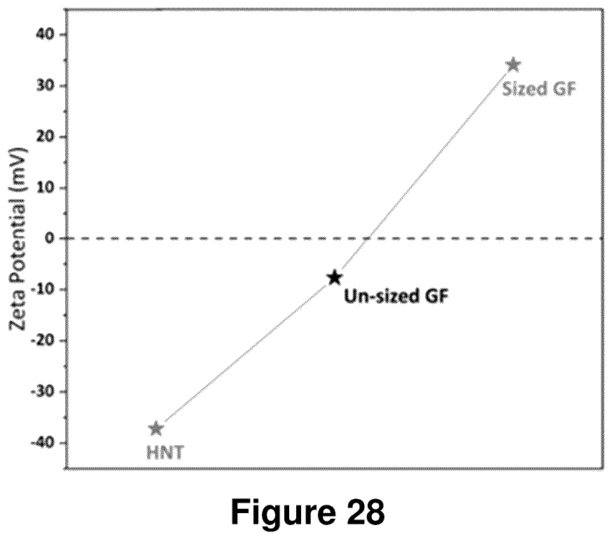

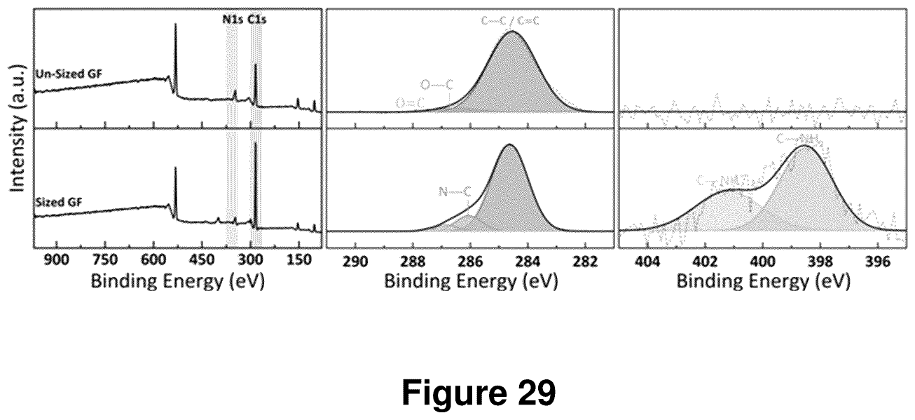

The bio-inspired hybrid composites were fabricated using industry-scale thermoplastic injection molding with specific processing conditions that facilitate the in situ self-assembly of the nano-sized HNTs onto the chemically modified micro-sized GFs in the PP matrix, producing a hierarchically structured fiber-assembly as reinforcement within the hybrid composites. A PP matrix was selected as it accounts for more than half of all polymeric materials used in the automotive industry, owing to its low cost, outstanding mechanical properties, and moldability. The hierarchical self-assembly present in the hybrid composites is attributed to the opposing electrostatic charges present on the reinforcements, characterized using Zeta Potential measurements, as later shown and described (FIG. 28, Supporting Information). Specifically, the chemically modified GFs exhibited a positive electrostatic charge of +34 eV induced by an aminosilane surface modification (FIG. 29, Supporting Information, shows the XPS spectra of the GFs, confirming the presence of aminosilane functionalization). On the other hand, HNTs possess a negative electrostatic charge of about −37 eV due to isomorphic substitutions of aluminum (Al(III)) and silicon (Si(IV)) cations on the basal surface. Moreover, the high shear and extensional deformation at elevated temperatures during the injection molding process combined with the volume exclusion effect induced by the GFs, physically constrains the motion of the HNTs within close proximity to the fibers' surface, fostering their self-assembly.

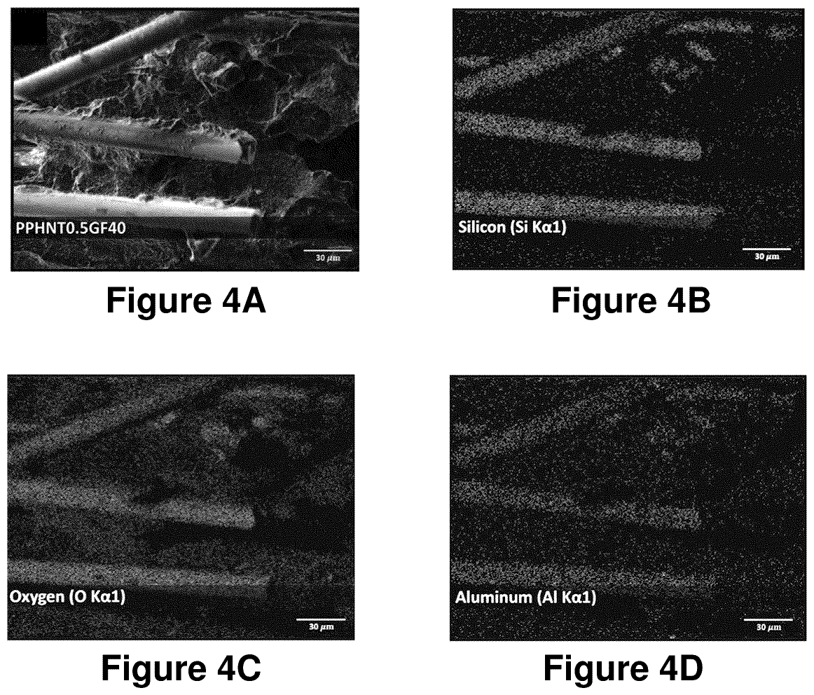

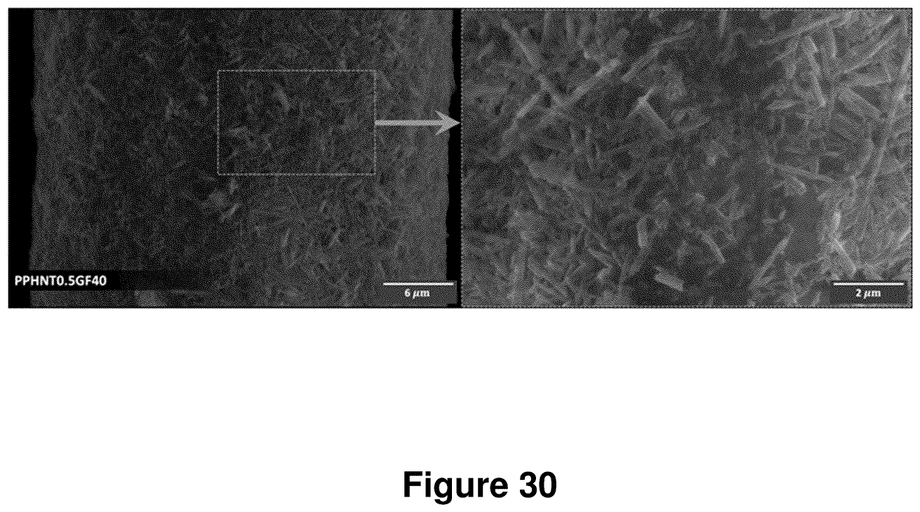

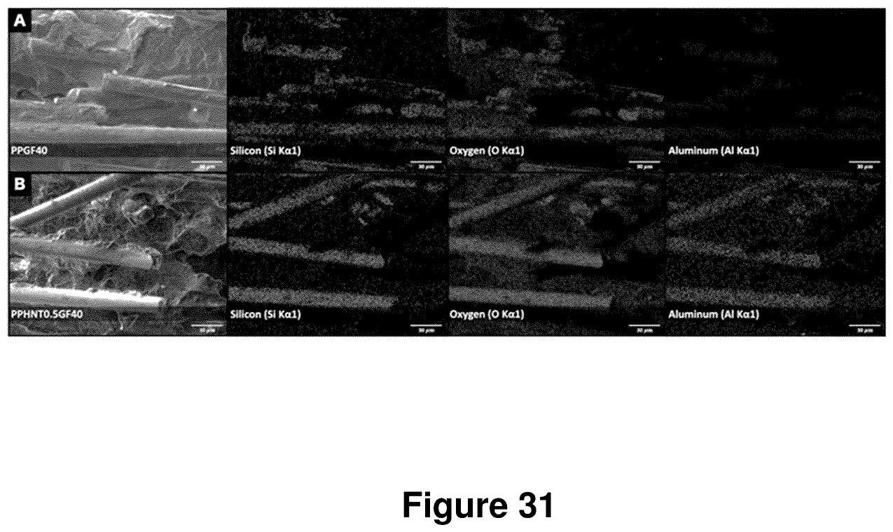

This hierarchical fibrous assembly is illustrated in FIG. 2 (see also FIG. 30, Supporting Information), whereby it is evident that the HNTs encapsulate the GFs surfaces, mimicking the hierarchical architecture of biological systems. Specifically, illustrated in FIG. 1, the hierarchical architecture of the polymer composite is analogous to the structure of osteons found in human compact bones, whereby the hierarchical fibrous assembly is resemblant of the core, and the trans-crystalline encapsulation shell is resemblant of the concentric lamella in osteons (further elucidation in subsequent discussion). The SEM-EDS mapping (FIGS. 4A to D) further showcases the preferential dispersion and distribution of the HNTs (aluminosilicates) onto the GFs (primarily composed of silicon dioxide) within the PP matrix, by selectively highlighting the alumina elemental phases. FIGS. 4A to D depict SEM-EDS mapping showcasing the preferential distribution of the HNTs onto the GFs surface, as demonstrated by the presence of aluminum (Al) on the GFs. In contrast, the SEM-EDS mapping for the biphasic PP/GF composites (shown in FIG. 31, Supporting Information), does not exhibit any aluminum phases, due to the absence of HNTs within the composite. Moreover, the suppression of the highly dense oxygen and silicon elemental signals on the GF surface within the hybrid composites substantiates the successful formation of the hierarchical fibrous assembly.

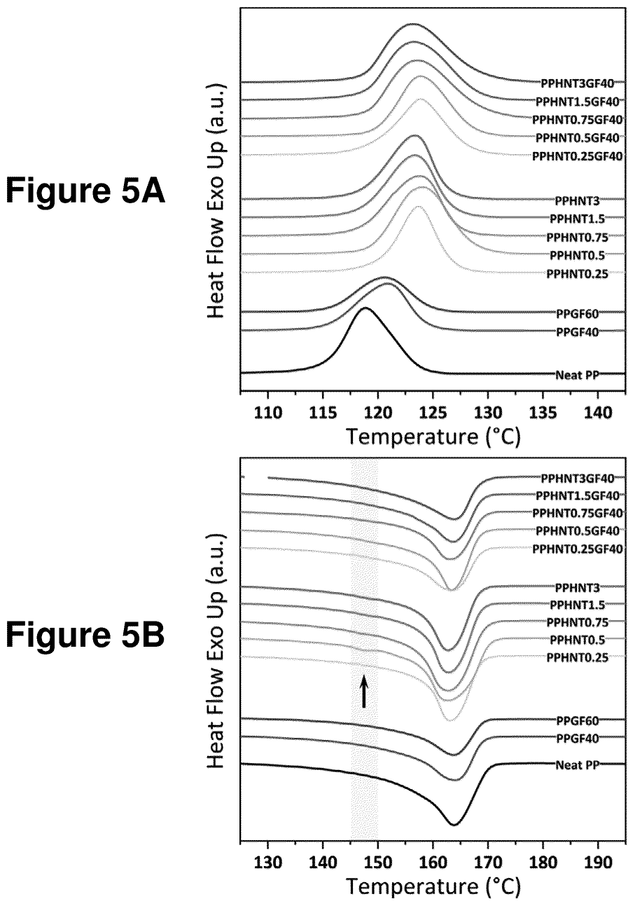

As the structure of engineered composites directly correlates to their inherent properties, it becomes essential to investigate their crystalline microstructure and bulk micro-morphology as a function of reinforcement concentration, orientation, and distribution. DSC cooling and second heating thermograms are illustrated in FIGS. 5A and 5B, for the biphasic and hybrid composites, with corresponding parameters tabulated in Table 1. For the biphasic PP/HNT composites, the introduction of HNT leads to an increase in the crystallization temperature (T_{c}), signifying that the crystallization of PP was accelerated in the presence of HNTs. An increase in T_{c} leads to a decrease in the degree of super-cooling (ΔT=Tₘ−T_{c}), which is directly proportional to the free energy of melting. This decrease indicates that crystallization occurred at a lower driving force, as the HNTs act as seeds for heterogeneous nucleation. Furthermore, the percent crystallinity ( [symbol] ) increased from 49.3% (Neat PP) to a maximum of 54.5% for the PPHNT0.5 composite, shown in Table 1. While the cooling thermograms are indicative of unimodal crystallization exotherms, the second heating thermograms exhibit a bimodal pattern, whereby the broadest shoulder is observable for PPHNT0.5.

FIG. 5A is a graph of DSC crystallization. FIG. 5B is a graph of DSC second heating thermograms for the fabricated composites.

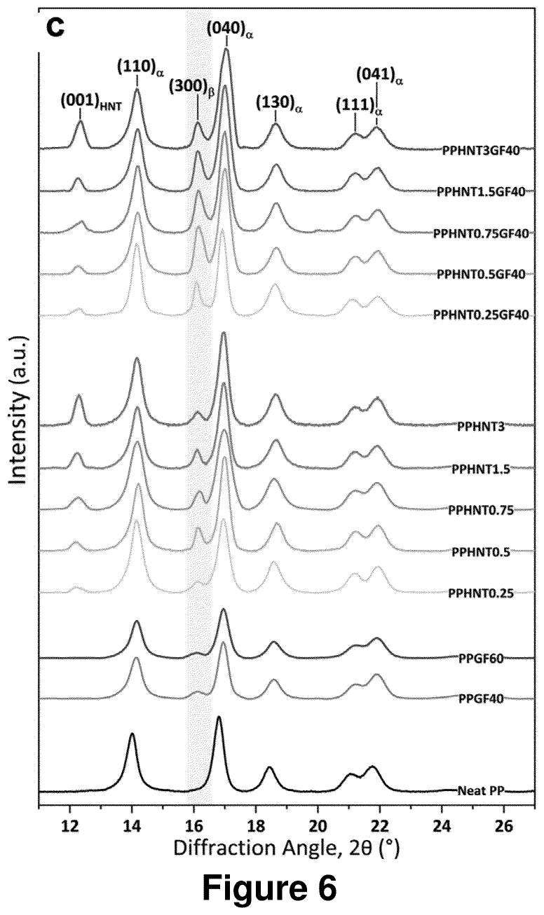

FIG. 6 is a graph of XRD diffractograms for the fabricated composites.

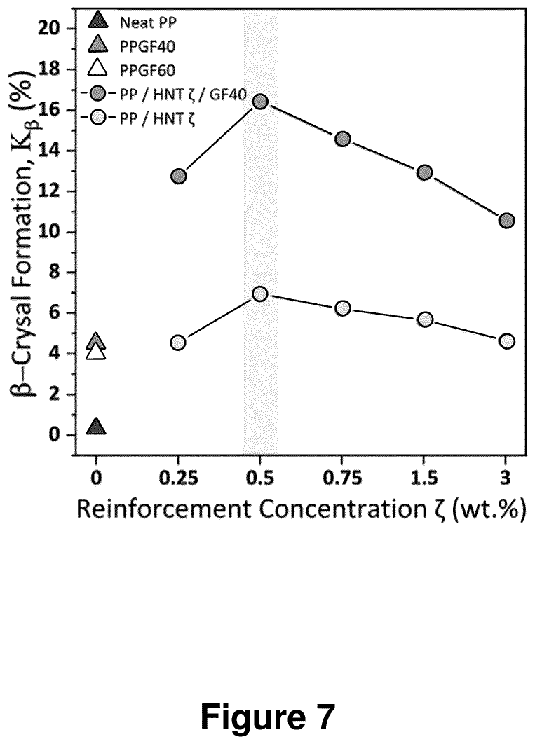

FIG. 7 is a graph showing β-crystal formation ( [symbol] _{β}), as a function of reinforcement concentration.

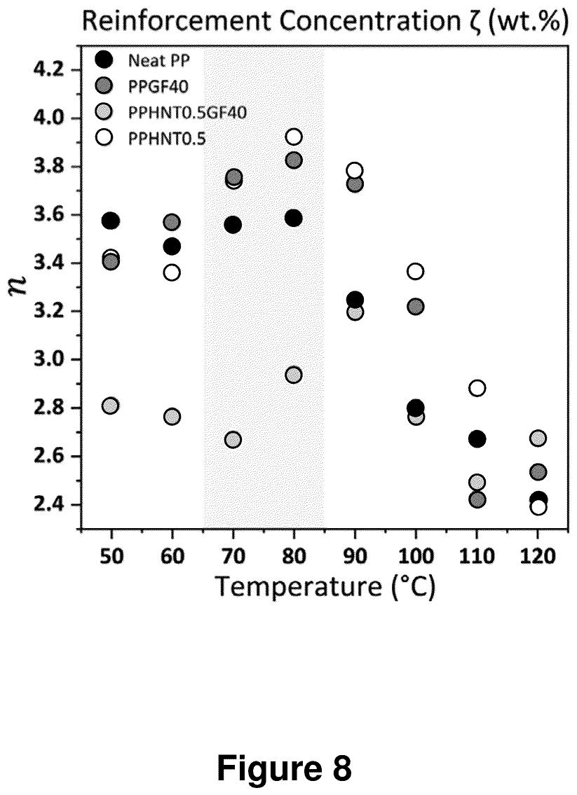

FIG. 8 is a graph depicting the dependence of the JMAK exponent n on the temperature of isothermal crystallization.

Table 1 shows the tabulated parameters extracted from the DSC thermograms and XRD Diffractograms. Tₘ is the Melting Temperature from DSC; T_{c} is the Crystallization Temperature from DSC; ΔT is theDegree of Supercooling from DSC; ( [symbol] _{c})_{DSC} is the Percent Crystallinity from DSC; ( [symbol] _{c})_{XRD} is the Percent Crystallinity from XRD; [symbol] _{β} is Total Fraction of β-crystal Formation from XRD; and Tᵣ is Degree of Trans-crystallization from XRD.

TABLE 1

| Sample | Tₘ | T_{c} | ΔT | ( [symbol] _{c})_{DSC} | ( [symbol] _{c})_{XRD} | [symbol] β | Tᵣ |
|---|---|---|---|---|---|---|---|
| Neat PP | 162.0 | 118.3 | 43.6 | 49.3 | 50.1 | 0.3 | 1.0 |
| PPHNT0.25 | 163.3 | 123.7 | 39.6 | 52.1 | 52.6 | 4.6 | 1.0 |
| PPHNT0.5 | 163.1 | 124.1 | 38.9 | 54.5 | 55.3 | 6.9 | 1.3 |
| PPHNT0.75 | 163.1 | 123.8 | 39.3 | 54.0 | 54.5 | 6.2 | 1.3 |
| PPHNT1.5 | 162.9 | 123.4 | 39.5 | 53.8 | 53.7 | 5.7 | 1.3 |
| PPHNT3 | 163.0 | 123.0 | 39.9 | 51.4 | 52.2 | 4.6 | 1.2 |
| PPGF60 | 164.0 | 120.9 | 43.1 | 51.9 | 52.3 | 4.6 | 1.1 |
| PPGF40 | 164.1 | 120.9 | 43.2 | 51.6 | 52.0 | 4.4 | 1.1 |
| PPHNT0. | 163.8 | 123.9 | 39.9 | 52.4 | 52.7 | 12.7 | 1.0 |
| 25GF40 | | | | | | | |
| PPHNT0. | 163.5 | 124.0 | 39.5 | 54.2 | 55.6 | 16.4 | 2.1 |
| 5GF40 | | | | | | | |
| PPHNT0. | 163.3 | 123.8 | 39.5 | 53.9 | 54.4 | 14.6 | 2.0 |
| 75GF40 | | | | | | | |
| PPHNT1. | 163.5 | 123.3 | 40.2 | 53.6 | 53.8 | 12.9 | 2.0 |
| 5GF40 | | | | | | | |
| PPHNT3GF40 | 163.4 | 123.1 | 40.3 | 51.1 | 50.9 | 10.6 | 2.0 |

Conversely, the biphasic PP/GF composites exhibit a small increase in T_{c} despite increasing GF concentration when compared to Neat PP. The consistent subtle increase in T_{c} implies that the inclusion of GFs does not increase the density of favorable sites for heterogeneous nucleation compared to HNTs. This effect may be attributed to the significantly lower aspect ratio of GF, or its amorphous structure. For the hybrid PP/HNT/GF composites, the DSC thermograms demonstrate that they inherit the crystallization behavior of the biphasic PP/HNT composites with the same concentration, whereby the T_{c} increased with increasing concentration of HNTs, regardless of GF concentration, up to 124.0° C. Furthermore, the second melting thermograms display a bimodal pattern, similar to those observed for the PP/HNT composites, indicating the existence of crystals beyond the predominant α-form. As a result, XRD was conducted on the fabricated composites to analyze the effect of the hierarchically structured fiber-assembly on the crystalline microstructure and polymorphism of the PP matrix.

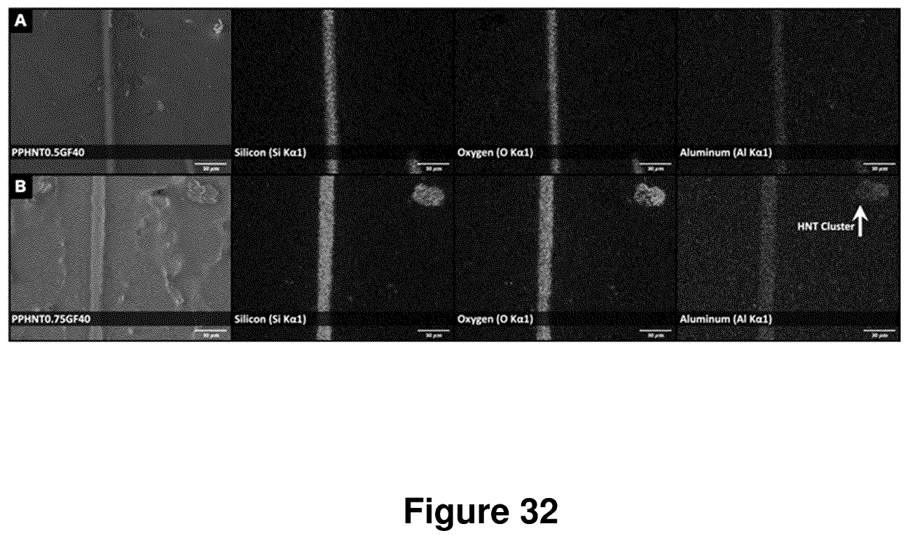

Qualitatively analyzing the XRD diffractograms shown in FIG. 6, three distinct phenomena are observable: (1) the introduction of the (001)_{HNT} crystallographic plane intrinsic to HNT, which increases exponentially as the HNT content increases, (2) the introduction of the (300)_{β} crystallographic plane, indicative of the presence of β-crystals, and (3) the presence of the (040)_{α} and (110)_{α} crystallographic planes which are related to the mechanisms of trans-crystallization. The occurrence of the (300)_{β} crystallographic plane confirms the presence of β-crystals within all the fabricated composites, directly correlating with the bimodal pattern observed in the second melting thermograms, as the melting temperature of β-crystals in PP is ≈10.9° C. lower than α-crystals (or ≈150° C.). Since β-crystals are known to impart superior mechanical properties, such as toughness, tensile strength, elongation at break, and impact strength, compared to α-crystals, it becomes imperative to quantify their formation and influence on the overall mechanical performance of the composites. Specifically, FIG. 7 elucidates the total fraction of β-phase formed ( [symbol] _{β}) within the composites, computed using the semi-quantitative Turner-Jones method, whereby it is apparent that the [symbol] _{β} is maximized at 16.4% for PPHNTO.5GF40. This behavior indicates that the HNTs act as heterogeneous nucleation sites for β-crystal formation. Since, both the biphasic PP/HNT and hybrid PP/HNT/GF composites exhibited the highest [symbol] _{β} with 0.5 wt % of HNT, we posit that this is attributed to the great dispersion of HNT; beyond this concentration, the HNTs begin to agglomerate. The SEM-EDS mapping of the PPHNT0.5GF40 and PPHNT0.75GF40 composites, (presented in FIG. 32, Supporting Information), confirms agglomeration when the HNT content surpasses 0.5 wt %. This compromise in β-nucleation efficiency occurs as the aspect ratio of the HNTs decreases due to agglomeration, leading to a reduction in heterogeneous nucleation sites. Furthermore, the [symbol] _{β} for PPHNT0.5GF40 ( [symbol] _{β}=16.4%) is greater than the additive sum of PPHNT0.5 and PPGF40 ( [symbol] _{β}=11.3%), demonstrating a clear synergistic effect. This behavior is attributed to the increased shear and extensional stresses induced during injection molding in the presence of GFs. Here, the GF increases melt viscosity (further elucidation in subsequent discussion), thereby favoring β-crystal formation.

Given that the intensity of the (001)_{HNT} crystallographic plane increases with increasing HNT content along with an increase in the intensities of the (040)_{α} crystallographic plane and a decrease of the (110)_{α} crystallographic plane, these emphasize the effectiveness of HNTs in promoting trans-crystallization. Generally, epitaxial crystalline growth on the surface of reinforcements in polymer composites is known to provide enhanced mechanical properties due to the improved stress transfer at the interface, thereby reducing fiber debonding and pullout. Therefore, it becomes imperative to comprehend the impact of the hierarchical fibrous assembly on the crystalline polymorphism and microstructure of hybrid composites, to optimize the extent of trans-crystallization and obtain a tailored interface. The ability of the bio-inspired reinforcement to induce trans-crystallization in the hybrid composites is quantified in Table 1, by considering the trans-crystallization ratio (Tr) of (040)_{α} and (110)_{α} intensities, as Tr=I(040)α/I(110)α. In general, the higher the Tr, the greater the amount of epitaxial growth encapsulating the hierarchical fibrous assembly, as the HNTs are electrostatically attached to the surface of the GFs. For the biphasic PP/HNT composites, the presence of epitaxial crystal growth is evident, reaching a saturation Tr of 1.3 with 0.5 wt % HNTs, further supporting the hypothesis that the HNTs significantly agglomerate beyond this concentration, thereby reducing their heterogeneous nucleation affinity. In contrast, for the biphasic PP/GF composites, negligible epitaxial crystal growth was detected when compared to Neat PP.

For the hybrid PP/HNT/GF composites, the Tr was optimized with 0.5 wt % HNTs, reaching saturation at 2.1, which is approximately a two-fold increase compared to PPGF40 (Tr=1.1). However, further increasing the HNT concentration resulted in no additional improvement in the amount of trans-crystallization, directly correlating to the behavior observed in the biphasic PP/HNT composites. The synergistically greater Tr is attributed to the hierarchical fibrous assembly, which preferentially distributed the HNTs along the GF surface, thereby directly increasing the available surface area to create complete encapsulation in trans-crystalline growth. However, for the hybrid composites with content greater than 0.5 wt % HNTs, the additional formation of epitaxial growth is hindered by an increased tendency to agglomerate, which limits the amount of HNTs available to electrostatically attach to the GF surface.

To delve deeper into the sole effect of the hierarchical fibrous assembly on the formation of trans-crystalline growth, FSC was utilized to investigate the crystallization kinetics across varying isothermal temperatures, employing the Johnson-Mehl-Avrami-Kolmogorov (JMAK) framework, which eliminates the effect of processing conditions on the resultant crystalline microstructure. Considering the results from the XRD analysis, which indicate a heightened degree of trans-crystalline growth in the presence of the hierarchical reinforcement, the JMAK exponent, n, is expected to decrease by roughly 1. This exponent represents the summation of contributions from the dimensionality of crystal growth, varying from 1 to 3 in accordance with dimensionality, as well as from the nature of crystal nucleation, varying from 0 for homogeneous to 1 for heterogeneous nucleation. Comparing the biphasic and hybrid composites, the nature of nucleation is identical, therefore, a decrease in n would be likely attributable to an increase in the relative proportion of 2D trans-crystalline growth as opposed to 3D spherulitic growth. To underscore the significance of the hierarchical fibrous reinforcement, a comparative analysis between the crystallization process in the hybrid composite (PPHNT0.5GF40) and PPGF40 was conducted, alongside Neat PP and PPHNT0.5. The determined values for the exponent n are depicted in FIG. 8, relative to the isothermal crystallization temperature. Above 100° C., both the biphasic and hybrid composites exhibit values of n closely approximating n=3. Below 100° C., Neat PP and the biphasic composites PPHNT0.5 and PPGF40 display a similar trend, while the hybrid composite PPHNT0.5GF40 distinctly deviates from the other samples, manifesting in significantly lower n values. Considering the observed behavior in Neat PP and the biphasic composites it is evident that the divergent crystallization pattern of the hybrid composite cannot be solely attributed to epitaxial crystal growth from the surfaces of HNTs or GFs alone. This behavior only manifests when both are present in a hierarchical structure within PP. This divergence aligns well with the XRD analysis, providing additional support to the notion that the hierarchical structure fosters the promotion of trans-crystalline growth.

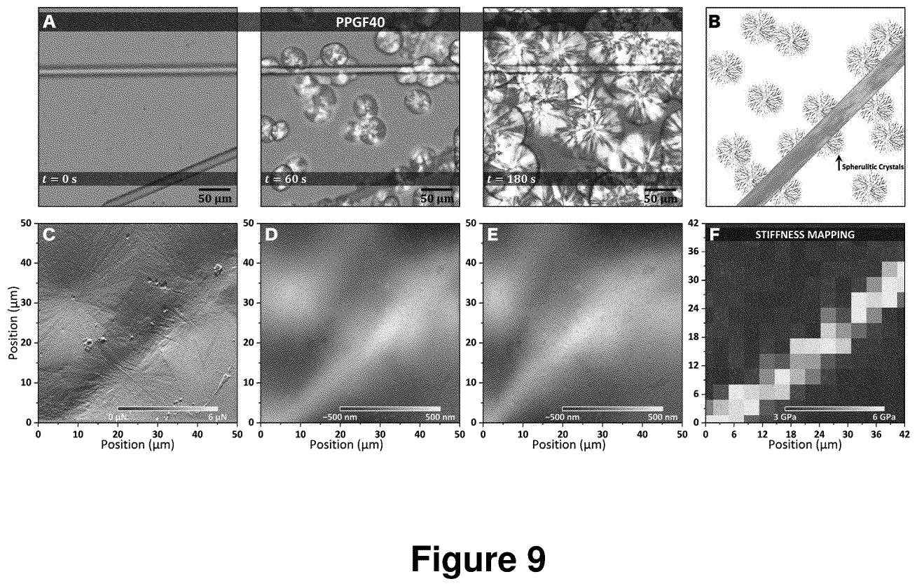

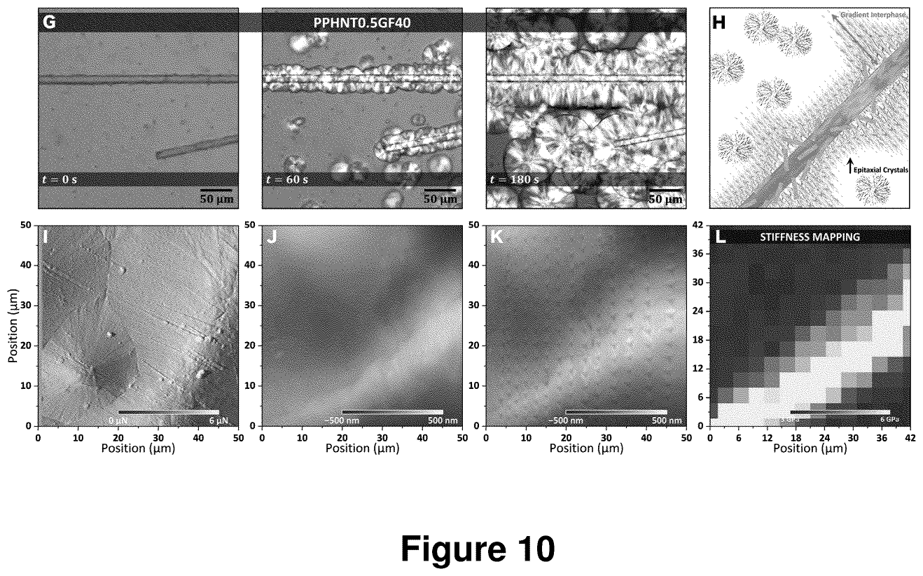

The crystalline microstructure and polymorphism produced by the hierarchical fiber assembly in the hybrid composite (PPHNT0.5GF40), compared to that of the biphasic composite (PPGF40), is showcased in the POM images in FIG. 9 and FIG. 10, with substantial trans-crystallization observable in the hybrid composite. This results in the formation of a concentric cylindrical core-shell architecture, where the hierarchical fiber assembly serves as the core and the trans-crystals constitute the shell, as illustrated in the schematic of FIG. 10 at H. In contrast, for the biphasic PP/GF composite, only the presence of the predominant spherulitic α-form is observable. This core-shell structure is reminiscent of and inspired by the strong and tough hierarchical core-shell structures seen in nature, such as compact bone and bamboo. Comparing with compact bone and bamboo architectures, the hierarchical fibrous assembly (that is, the electrostatically assembled HNTs on the GF surface) core corresponds to the haversian canals in compact bone and the inner lamellae in bamboo, whereas the encapsulating trans-crystalline shell corresponds to the outer, concentric layers of lamellae in compact bone and the primary cell wall in bamboo. As a result, this hierarchical architecture is directly comparable to the osteons in compact bone and lamellae bundles in bamboo, whereby the rest of the polymer matrix is comparable to the collagen matrix in compact bone, and the cellulose individual lamellae in bamboo, which independently hold neighboring osteons or bamboo lamellae together. An illustration of this bio-inspired architecture is shown in FIG. 1 and FIG. 2, which showcase the comparison between the natural core-shell structure of compact bone to the synthetic hierarchical architecture presented in this work.

At A, FIG. 9 shows POM images showcasing the variations in crystalline microstructure of the matrix with respect to time. At B, FIG. 9 shows a schematic representation of the crystalline microstructure. At C, FIG. 9 shows a Pre-indentation gradient. At D, FIG. 9 shows a Pre-indentation topography. At E, FIG. 9 shows Post-indentation topography SPM images. At F, FIG. 9 shows Nano-indentation reduced modulus (Eᵣ) mapping. Similarly, the Hybrid PP/HNT/GF composites are depicted in FIG. 10. At G, FIG. 10 shows POM images showcasing the variations in crystalline microstructure of the matrix with respect to time. At H, FIG. 10 shows Schematic representation of the crystalline microstructure. At I, FIG. 10 shows Pre-indentation gradient. At J, FIG. 10 shows Pre-indentation topography. At K, FIG. 10 shows Post-indentation topography SPM images. At L, FIG. 10 shows Nano-indentation reduced modulus (Eᵣ) mapping.

To elucidate the impact of the crystalline microstructure on the fabricated composite's mechanical properties and stress transfer, nanoindentation stiffness mapping was employed to assess the local nano-scale stiffness variations within the composites. Specifically, the fiber/matrix interface regions were analyzed in the biphasic composites and the hybrid composites, as showcased in FIGS. 9 and 10. For the biphasic PP/GF composites, a sharp stiffness transition is evident at the interface between GF and the PP matrix (FIG. 10 at L), which is indicative of a negligible interphase region. This configuration leads to high-stress concentration and inadequate stress transfer under mechanical loading, thereby limiting the reinforcement behavior of GF alone. The reduced modulus (Eᵣ), shown in FIG. 9 at E and FIG. 10 at L, is a material property used to describe the stiffness of a material when subjected to specific types of deformation, such as indentation or contact between surfaces, and takes into account the effects of both the material's intrinsic stiffness and the influence of the contacting bodies or surfaces. The Eᵣ of each phase in each respective composite was determined by averaging the Eᵣ values detected for each phase. This determination was made using nano-indentation and scanning probe microscopy (SPM) mapping, as detailed in Section S1 (Supporting Information): Morphology and Interfacial Interactions of the Supporting Information. In the GF region, an Eᵣ of 6.24±0.23 GPa was detected, while at the fiber/matrix interface and in the bulk polymer matrix, an Eᵣ of 3.34±0.07 and 3.34±0.04 GPa were detected, respectively. In contrast, for the hybrid PP/HNT/GF composites, the presence of the cylindrical core-shell architecture has led to the formation of a gradient stiffness, spanning from the high-stiffness hierarchical fibrous assembly region to the low-stiffness PP matrix. The gradient is attributed to the presence of a stiffer interphase (constituting the shell in the cylindrical core-shell architecture). This interphase functions to distribute the stress differential across a larger area, consequently mitigating maximum localized stress and facilitating more effective stress transfer from the matrix to the reinforcement, as discussed by Sansone et al. In the region covering the hierarchical fibrous assembly of the hybrid composite, an Eᵣ of 7.87±0.27 GPa was detected, with 5.31±0.32 GPa at the fiber/matrix interphase (shell region), and in the bulk polymer matrix, an Eᵣ of 3.36±0.08 GPa was detected. The presence of trans-crystals within the shell of the hybrid composite, combined with the presence of the high-stiffness nanofiller electrostatically attached to the GFs resulted in a higher Eᵣ over the hierarchical fibrous assembly, compared to the GF region in the biphasic composite. Furthermore, the presence of trans-crystals in the cylindrical core-shell structure contributes to the stiffer interphase in the hybrid composite, justifying the higher stiffness compared to the predominant spherulitic α-phase in the bulk PP matrix. These findings validate the influence of trans-crystallization in improving the interfacial interactions of the hierarchically structured composites, as evidenced by the presence of a wider (≈14 μm) and stiffer fiber/matrix interphase.

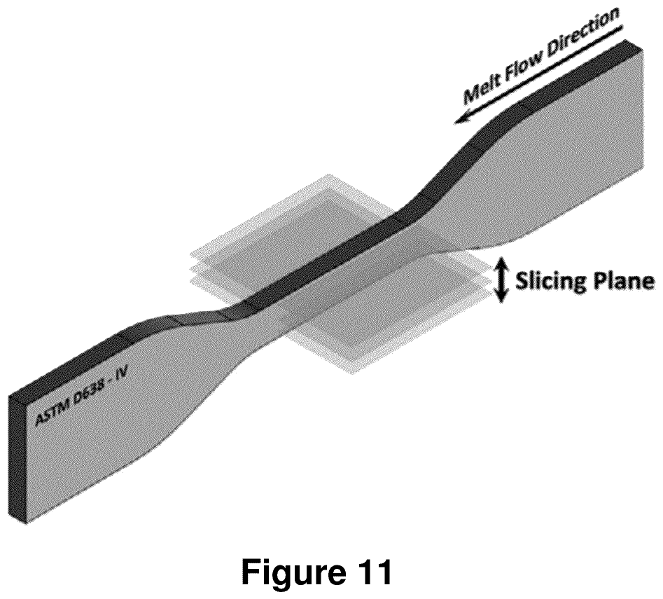

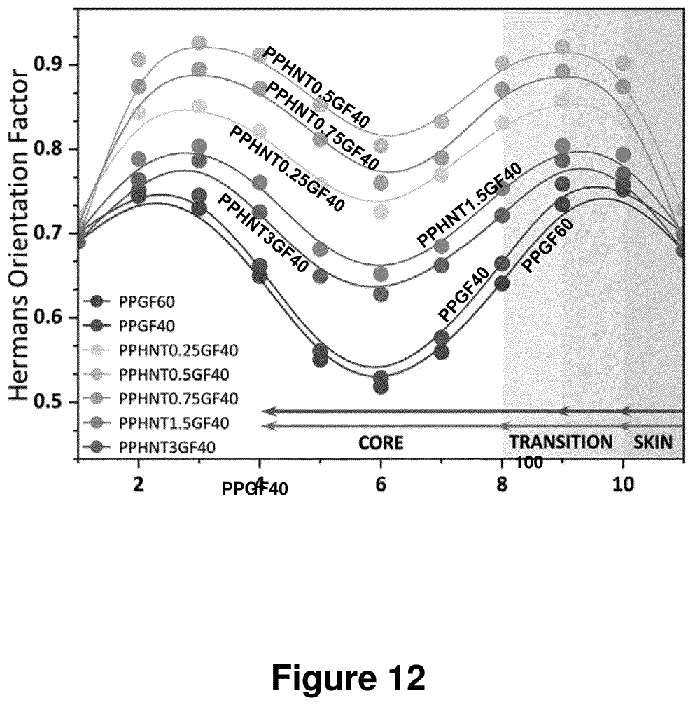

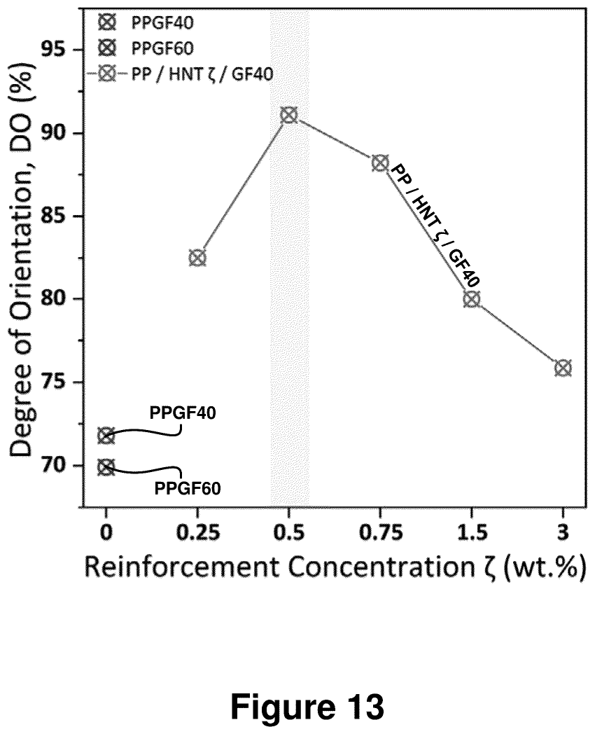

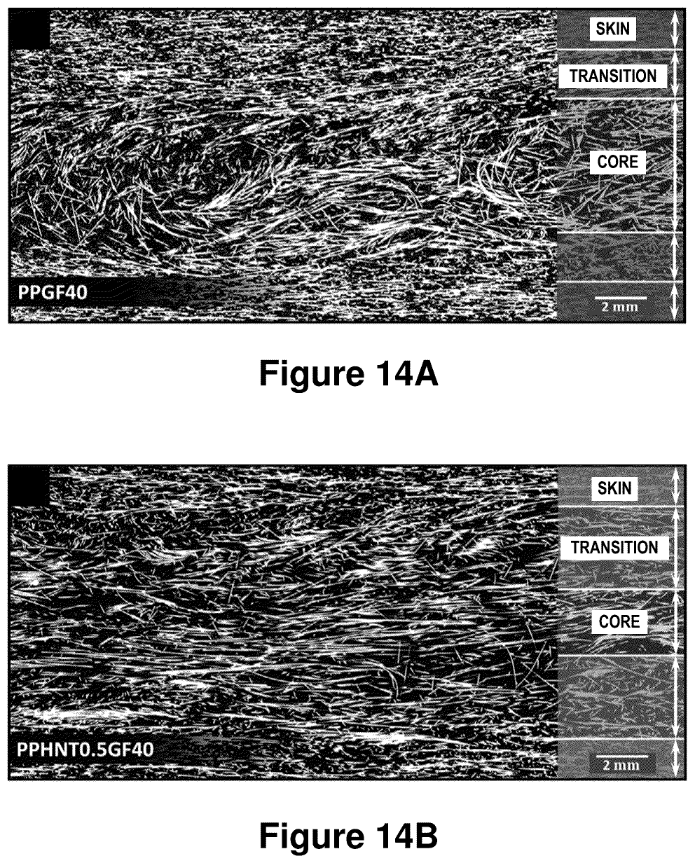

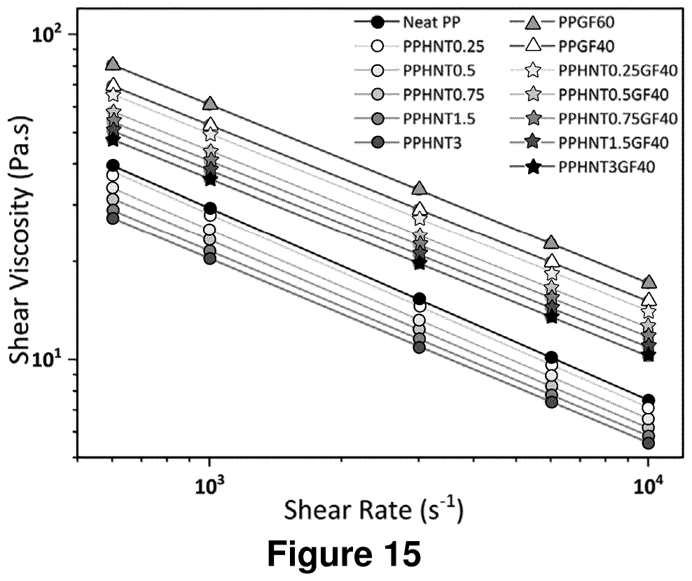

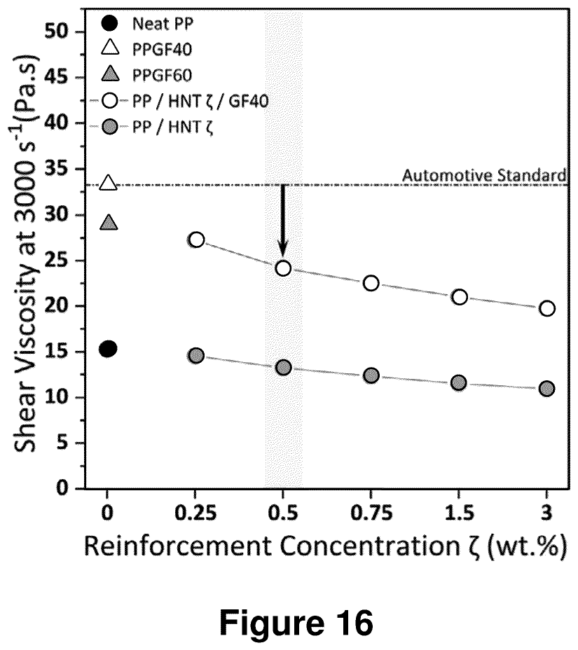

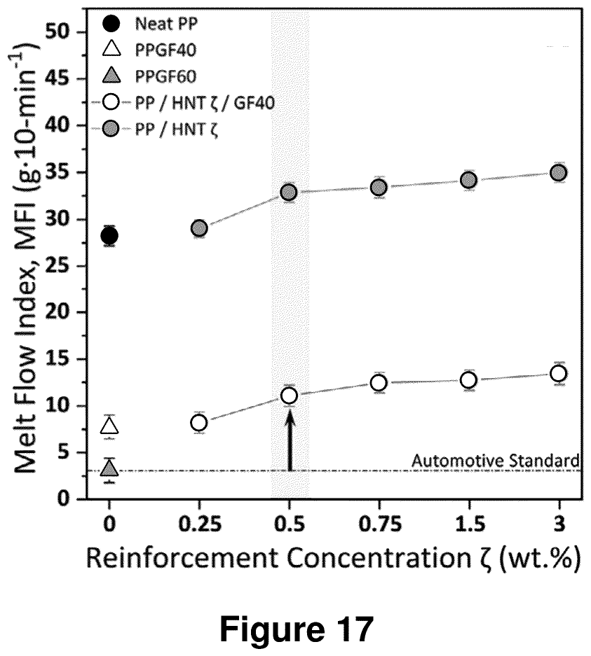

FIG. 11 is a schematic illustrating the micro-CT slicing direction. FIG. 12 is graph of a Hermans Orientation Factor of select fabricated composites versus position (through thickness). FIG. 13 is a graph of Degree of orientation (DO) of the GFs versus reinforcement concentration. FIG. 14A is a micro-CT image of PPGF40, and FIG. 14B is a micro-CT image of PPHNT0.5GF40 to visualize and quantify the effect of HNTs on the melt flow and GF orientation. FIG. 15 is a graph of shear viscosity versus shear rate for the fabricated composites, in a capillary rheometer at high shear rates. FIG. 16 is a graph of a direct comparison of the shear viscosities at a constant shear rate of 3,000 s⁻¹ with varying HNT content. FIG. 17 is a graph of the Melt-flow index (MFI) for the fabricated composites, showcasing the direct correlation between viscosity and fiber orientation.

The influence of the hierarchical fibrous assembly on the microstructural architecture of the hybrid composites, compared to that of the biphasic composites, was assessed using micro-computed tomographic (micro-CT) scanning across the thickness of the composite's cross sections. Here, the Hermans Orientation Factor was determined (see Experimental Section for details), as shown in FIG. 12, whereby S equals 1 for perfect orientation. For the biphasic PP/GF composites, it is apparent that a complex fiber orientation distribution exists, as the Hermans Orientation Factor varies throughout the composite's cross-section, with the lowest fiber DO observable within the core region. During the injection molding process, the reinforcements are subjected to high shear rates ranging from 10³ to 10⁴ s⁻¹, as the composite melt is injected into the mold cavity, leading to an overall preferential fiber alignment along the flow direction. Initially, the fountain flow at the melt front produces orthogonally aligned the fibers relative to the flow direction. However, upon contact with the mold walls, the fibers reorient parallel to the flow direction due to the extensive shear stresses (Skin Region). Further behind the melt front, shear flow dominates and generates higher levels of fiber orientation (Transition Region), while the melt subjected to minimal shear flow will foster a more disordered fiber orientation (Core Region), with respect to the melt flow direction. As such, a complex fiber orientation distribution is produced, directly correlating to the varying Hermans Orientation Factor across the composite's cross section, which aligns well with the previous observations made by Thomason et al. The overall DO for PPGF40 and PPGF60, shown in FIG. 13, which correspond to the average Hermans Orientation Factor, are ≈0.72 and 0.69, respectively.

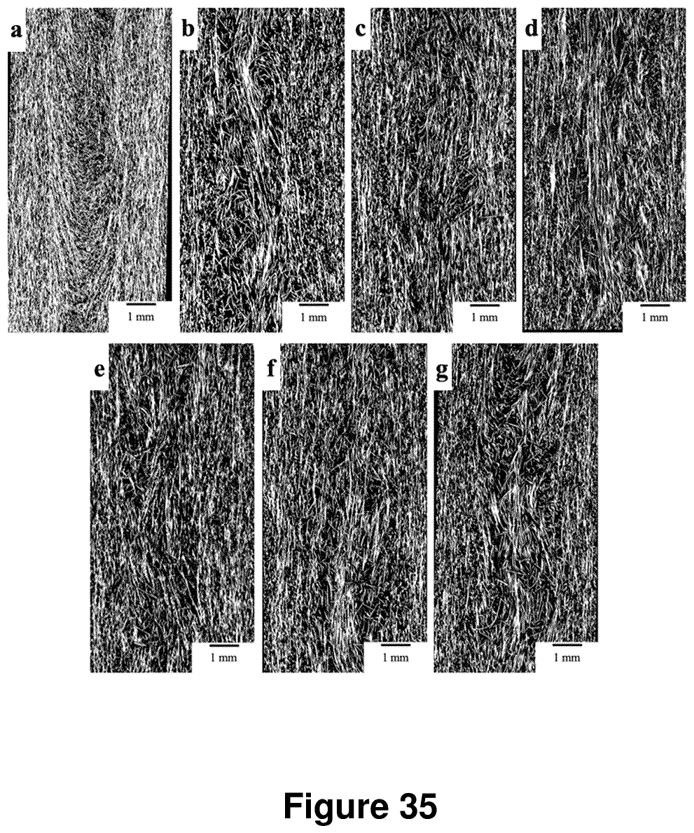

For the hybrid PP/HNT/GF composites, a very similar behavior to that of the biphasic composites is observed, whereby the transition and core region shows the highest and lowest Hermans Orientation Factor, respectively, as shown in FIG. 12. However, upon closer examination, an expansion of the highly oriented transition region across the composite thickness is apparent, along with a compression of the less oriented core region, as illustrated in the micro-CT images of FIG. 14A and FIG. 14B (see also FIG. 35, Supporting Information). Also, the difference in Hermans Orientation Factor between the transition region and the core region is relatively less pronounced, compared to the biphasic composites, resulting in an overall increased DO for the hybrid composites. Specifically, the highest DO for the hybrid composites was achieved with 0.5 wt % HNT reaching ≈0.91, whereby further increasing the HNT content decreased the overall DO. The consistently higher DO observed throughout the thickness, encompassing the skin, transition, and core regions, in the hybrid composite suggests that the GFs are more aligned in the melt flow direction during injection molding. This implies that the presence of HNT promotes the disentanglement of GFs. This behavior could be attributed to the inherent lubricating properties of HNTs, which act as rolling contact bearings that impact the sliding surfaces to reduce the overall friction, thus, facilitating the disentanglement of the GFs with the melt flow during injection molding. As such, the rheological properties of the biphasic and hybrid composites were assessed, as shown in FIG. 15, to elucidate the melt flow behavior during injection molding at a temperature of 230° C.

For the biphasic PP/HNT composites, it is evident that the viscosity decreased with increasing shear rates, indicative of shear-thinning behavior. Also, it is observable that increasing the HNT concentration decreases the melt viscosity (shear-thinning effect), as the HNTs act as physical lubricants. In contrast, increasing the GF concentration in biphasic PP/GF composites increases the melt viscosity. For the hybrid PP/HNT/GF composites, a similar shear thinning behavior is observed, whereby the melt viscosity decreases with increasing HNT concentration. Specifically, analyzing the viscosity under injection molding conditions with a shear rate of 10³ s⁻¹, as shown in FIG. 16. FIG. 16 demonstrates the viscosity decreased by 27% and 17% for PPHNT0.5GF40, compared to PPGF60 and PPGF40, respectively. Additionally, the drop in viscosity with the addition of HNTs is further supported by the MFI results, as shown in FIG. 17. Notably, PPHNT0.5GF40 achieved a 255% higher MFI than that of the automotive standard (PPGF60) and 43% higher than that of its biphasic counterpart PPGF40, showcasing the ability of HNTs in enhancing the processability of the hybrid composites (as detailed in Section S3, Supporting Information).

As a result, the enhanced overall DO for the hybrid composites, stemming from the expansion of the transition region and suppression of the core region, can be directly attributed to the decreased viscosity of the hybrid composites. This reduction in viscosity occurs as the addition of HNTs creates a lubricating surface on the GFs, facilitating disentanglement in the flow direction. Furthermore, reducing the viscosity to a certain extent will require less shear stress to preferentially orient the fibers along the flow direction, causing the transition region to expand and the core region to compress, as seen for PPHNT0.5GF40. However, surpassing the HNT concentration of 0.5 wt % will result in the over-lubrication of the composite melt, thereby diminishing the preferential orientation of the fibers due to the insufficient melt strength required to constrain the motion of the fibers before melt solidification. The subsequent sections of this work will detail the structure-property relationships associated with the hierarchical fibrous assembly and cylindrical core-shell architecture in the frame of mechanical performance, thermal conductivity and thermal management performance, and thermal stability and flammability of the hybrid composites.

### 1.2 Mechanical Performance

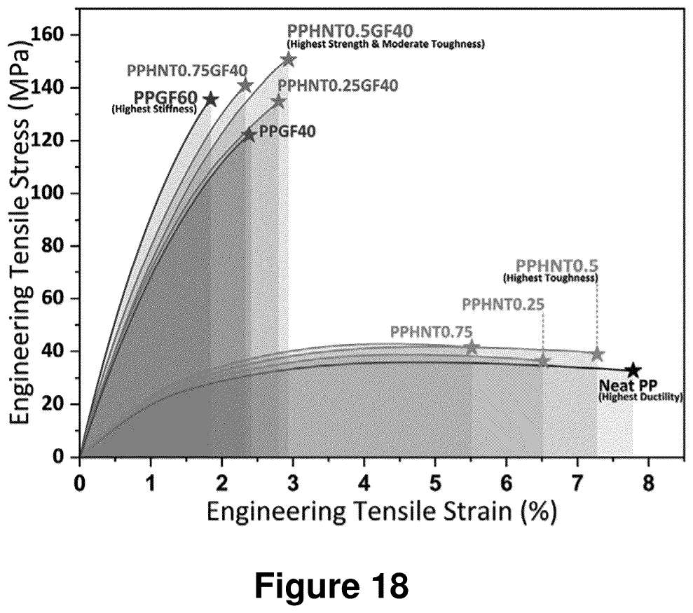

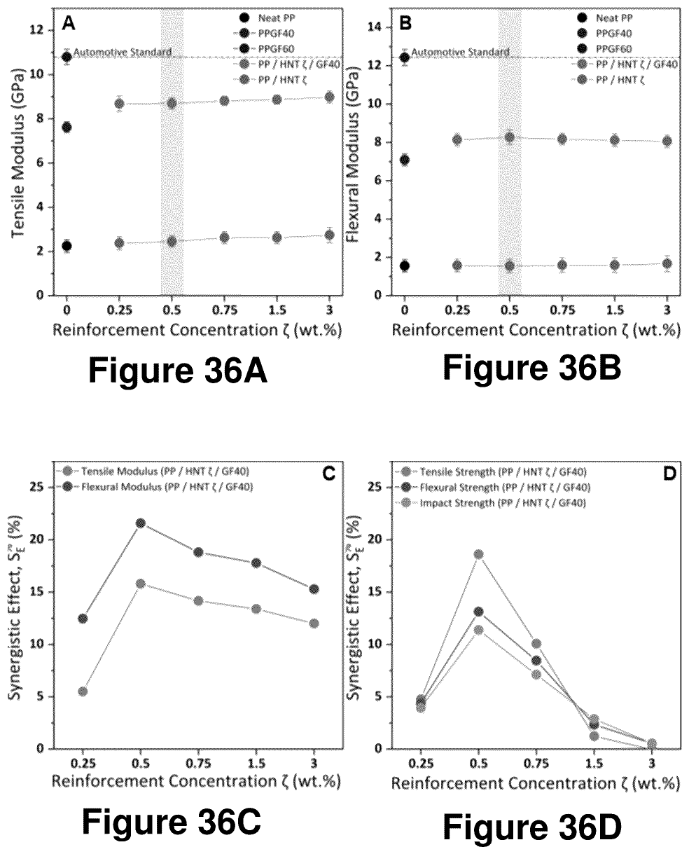

The mechanical properties of the fabricated composites were evaluated by uniaxial tension, three-point bending, and Izod impact tests, to highlight the degree of enhancement and synergistic effect induced by the hierarchical fibrous assembly in the hybrid composites, compared to that of their biphasic counterparts. The mechanical strengths of the prepared materials are illustrated in FIGS. 18 to 21, with corresponding modulus measurements presented in FIG. 36 (Supporting Information).

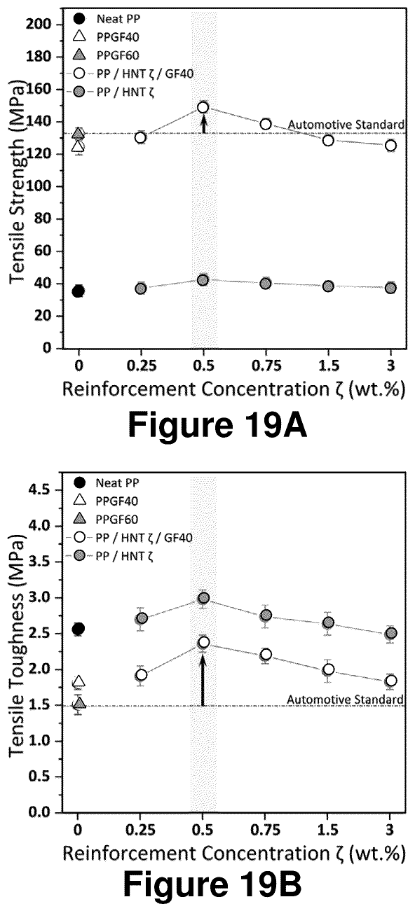

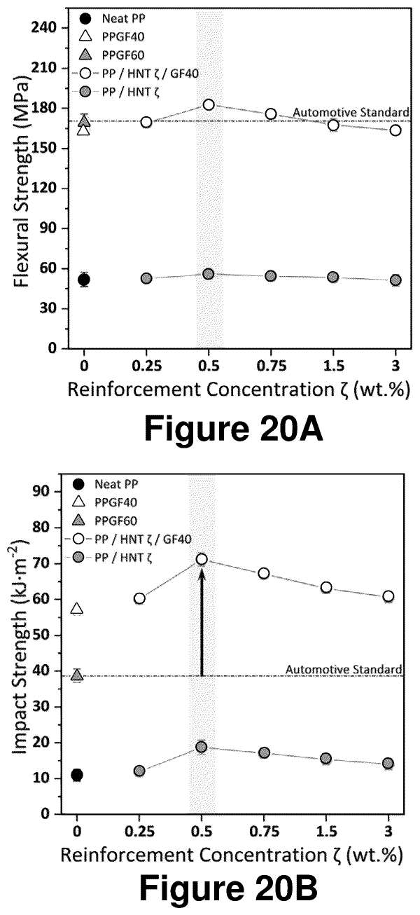

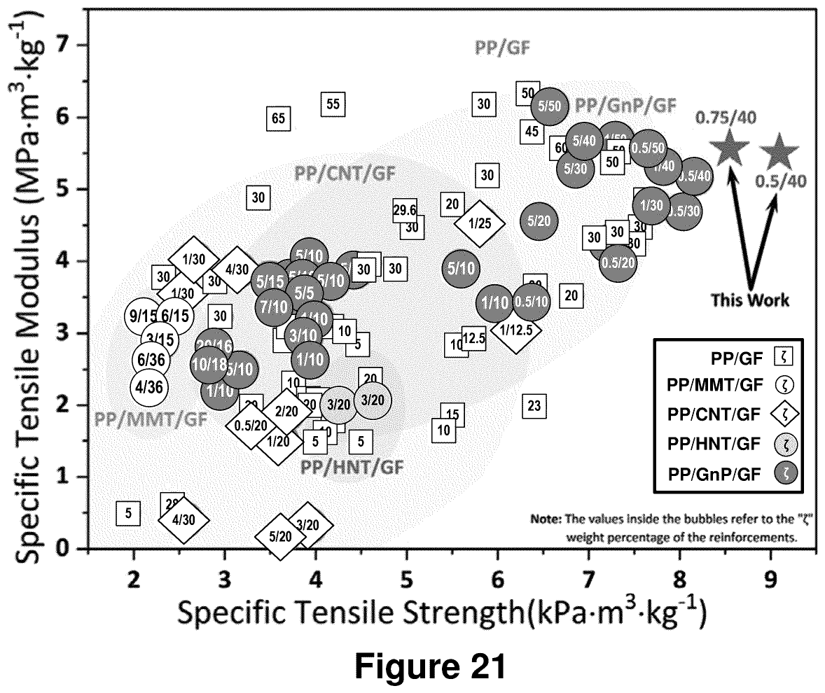

FIG. 18 is a graph depicting stress-strain curves for select fabricated composites. FIG. 19A is a graph of Tensile Strength. FIG. 19B is a graph of Tensile Toughness, FIG. 20A is a graph of Flexural Strength. FIG. 20B is a graph of Impact Strength with respect to reinforcement concentration for the fabricated composites, and FIG. 21 is a Material Selection Chart for Specific Tensile Modulus with respect to Specific Tensile Strength of collected literature data, with superimposed experimental results.

To validate the performance of the fabricated composites, PPGF60 was selected as a baseline for the mechanical properties and weight, as it is widely considered the standard for high-performance applications, such as structural automotive components. The tensile strength, tensile toughness, and flexural strength of the fabricated composites are shown in FIGS. 19A, 19B, and 20A. For the biphasic PP/GF composites, the tensile strength and flexural strength increase proportionally with increasing GF concentration, according to the expected rule-of-mixture, while the tensile toughness decreases significantly due to the reduced ductility. However, for the biphasic PP/HNT composites, the tensile strength, tensile toughness, and flexural strength display a maximum improvement of ≈19%, ≈16%, and ≈8%, respectively, for PPHNT0.5, relative to Neat PP. Similarly, the impact strength (FIG. 20B) shows a maximum improvement of ≈71% for PPHNT0.5, relative to Neat PP, whereby further increasing the HNT concentration reduces the impact performance of these composites. This behavior is directly attributed to the increased degree of agglomeration that occurs above this threshold, resulting in high-stress concentration sites that adversely affect the composite's strength.

For the hybrid PP/HNT/GF composites, the tensile strength, tensile toughness, flexural strength, and impact strength are optimized with 0.5 wt % HNT, demonstrating comparable trends to their biphasic counterparts with the addition of synergistic enhancement. Specifically, compared to the automotive standard (PPGF60), PPHNT0.5GF40 presents an increase of ≈13%, ≈56%, ≈7%, and ≈84% in tensile strength, tensile toughness, flexural strength, and impact strength, respectively, while providing a 20% weight reduction. Fractographies of the biphasic PPGF40 composite and hybrid PPHNT0.5GF40 composite obtained from tensile testing, are presented in Figure S6 (Supporting Information). The micro-failure modes observed in these composites include matrix cracking, fiber breakage, fiber debonding, and fiber pullout, which are the primary micro-failure modes present in PP-based composites reinforced with long GF. Comparing the fracture surfaces of the biphasic PP/GF composite with the hybrid composite reveals a significant difference in the extent of fiber pullout experienced by the composites. The hybrid composite exhibited notably reduced fiber pullout, indicating that the hierarchical fibrous assembly fosters a stronger fiber/matrix interface. Moreover, the fractography of hybrid composite demonstrates a higher incidence of fiber breakage, supporting the role of hierarchical fibrous assembly in facilitating stress transfer from the matrix to the reinforcement.

The remarkably enhanced mechanical properties of these hybrid composites are attributed to the synergistic effect induced by the bio-inspired cylindrical core-shell architecture, which was evaluated to elucidate the trends associated with the various combinations of filler loadings (FIG. 36, Supporting Information). The optimum effective synergistic effect (SE %) for the tensile, flexural, and impact strengths of the hybrid composites is observed with 0.5 wt % HNTs, reaching a maximum SE % of ≈19%, ≈13%, and 11%, respectively, in PPHNT0.5GF40. This behavior is directly attributed to the optimized hierarchical fibrous assembly being encapsulated in trans-crystalline growth, as per FIG. 9 and FIG. 10, which induces a gradient interphase at the fiber/matrix interface that expedites stress transfer, due to the absorption/adsorption of polymer chains onto the fillers. Simultaneously, the matrix is toughened, due to the maximum formation of β-crystals, which are known to provide superior mechanical performance compared to α-crystals, due to the mechanisms of strain hardening, as well as an increased resistance against crack propagation. Additionally, the synergistic effect can also be attributed to the increased DO, as shown in FIG. 13. A greater alignment of fibers in the mechanical loading direction increases the material anisotropy, improving its response to applied forces along the axis of the reinforcing phase's alignment. Moreover, a more uniform distribution in fiber orientation (i.e., lower degree of entanglement of GFs) can promote stress distribution when the material is subjected to mechanical loading. This, in turn, can lead to a tougher response, as stress is more evenly distributed throughout the material.

The material selection chart presented in FIG. 21 highlights the specific tensile modulus with respect to specific tensile strength of collected literature data compared to the experimental data presented in this work, showcasing the efficacy of this hybrid system in producing strong, stiff, and lightweight high-performance materials. This is attributed to the advantageous stiffness-to-weight and strength-to-weight ratios of these composites. It is evident that the optimum performing composite is PPHNT0.5GF40, whereby its stiffness-to-weight (5.5 MPa m³ kg⁻¹) and strength-to-weight (9.1 kPa m³ kg⁻¹) ratios are maximized. Furthermore, it is observable that the hybrid composites presented in this study outperform the specific tensile properties of previously published hybrid composites in the literature, especially with comparable GF concentrations. For example, PPHNT0.5GF40 presented in this work exceeds the highest recorded literature value for a PP/GnP/GF system, for the same concentration of reinforcements, by 6% and 11% for specific stiffness and specific strength, respectively.

Overall, the hybrid composites presented in this work containing an optimized cylindrical core-shell reinforcement, provide synergy-induced mechanical properties that biphasic composites are unable to achieve, due to their inability to produce a tailored interphase with optimal interfacial interactions, enhanced crystalline microstructure containing β-crystals, and improved reinforcement DO. In fact, these composites were employed to fabricate battery casings with complex geometries for commercial electric vehicles (as detailed in Section S3, Supporting Information), demonstrating their viability for use in high-performance industrial applications, with improved processability and superior economic potential.

### 1.3 Thermal Conductivity and Thermal Management Performance

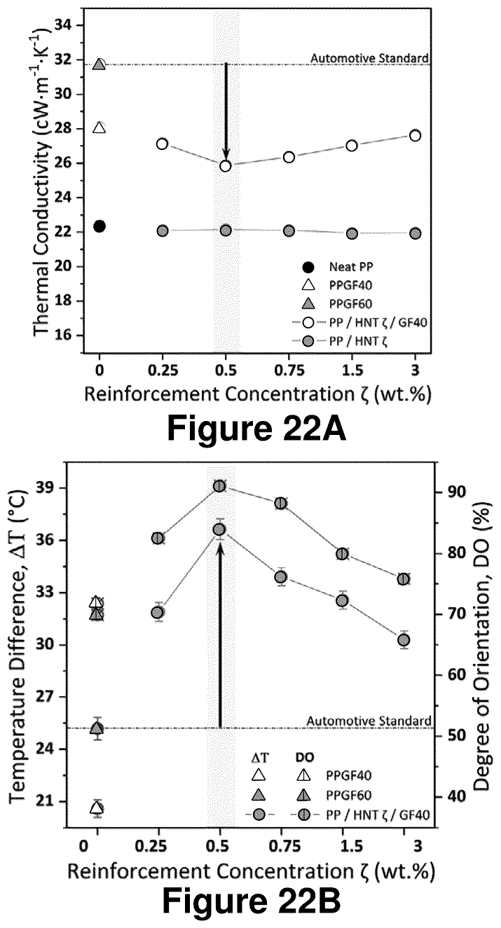

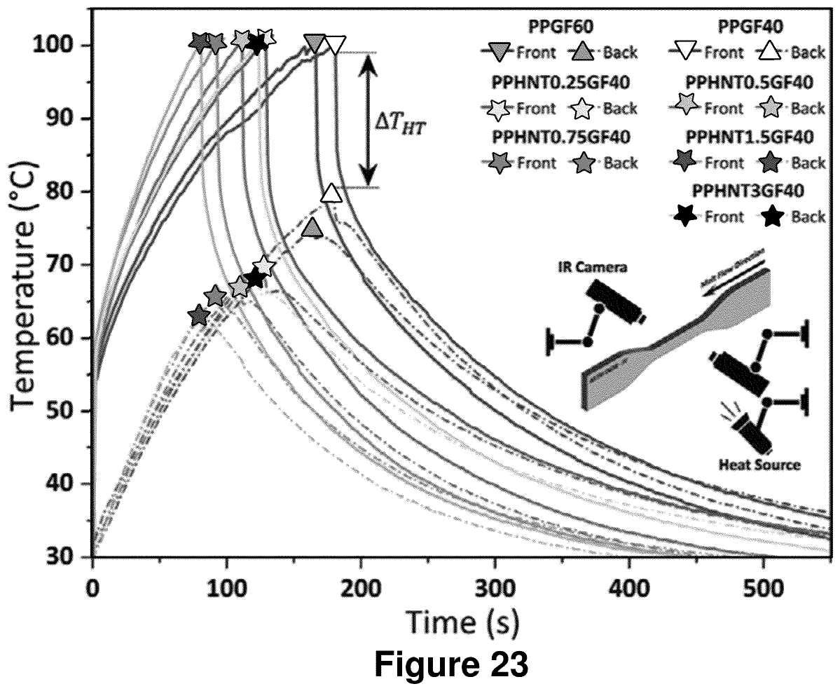

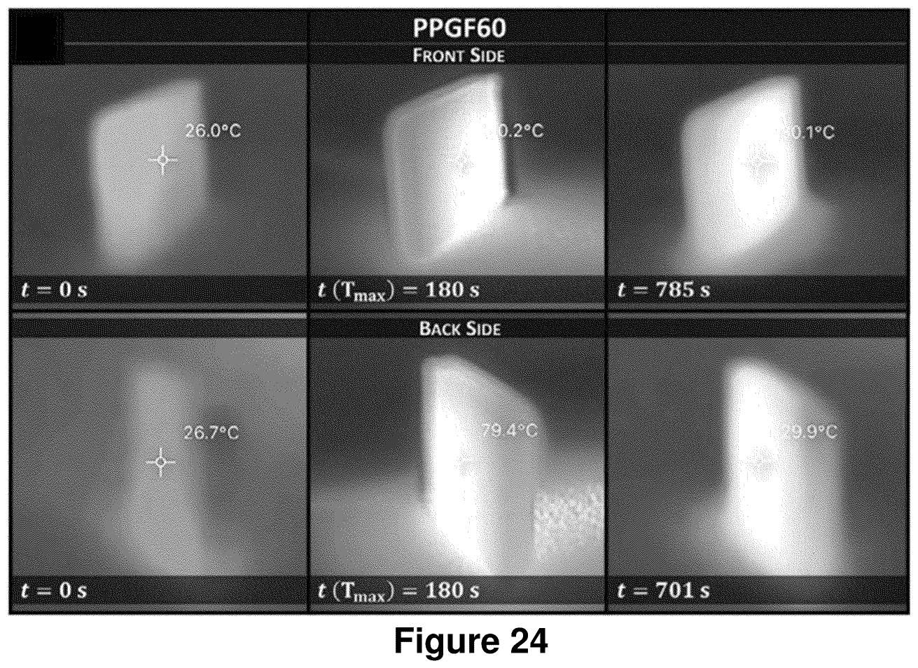

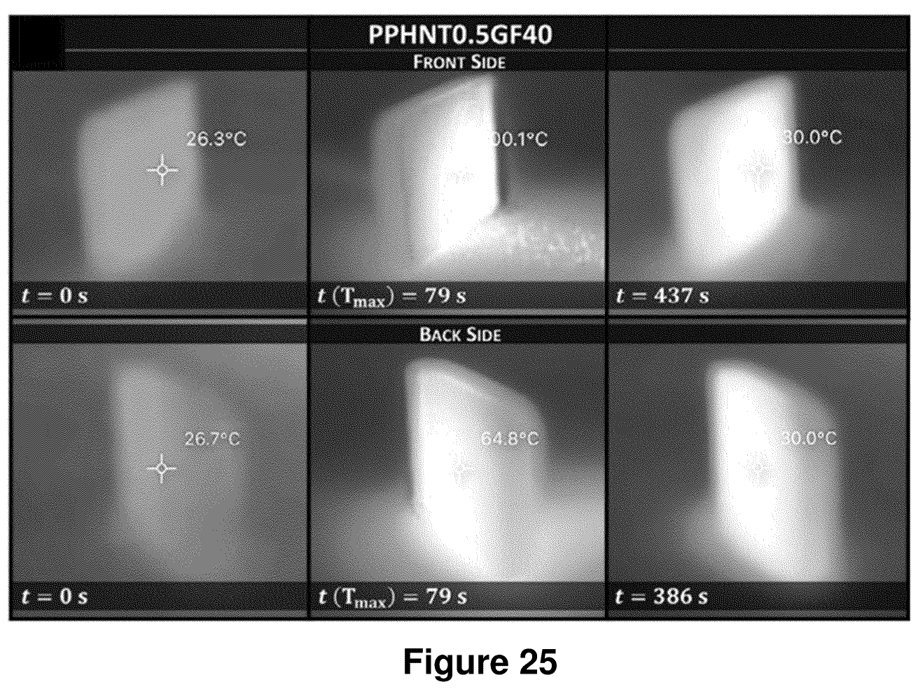

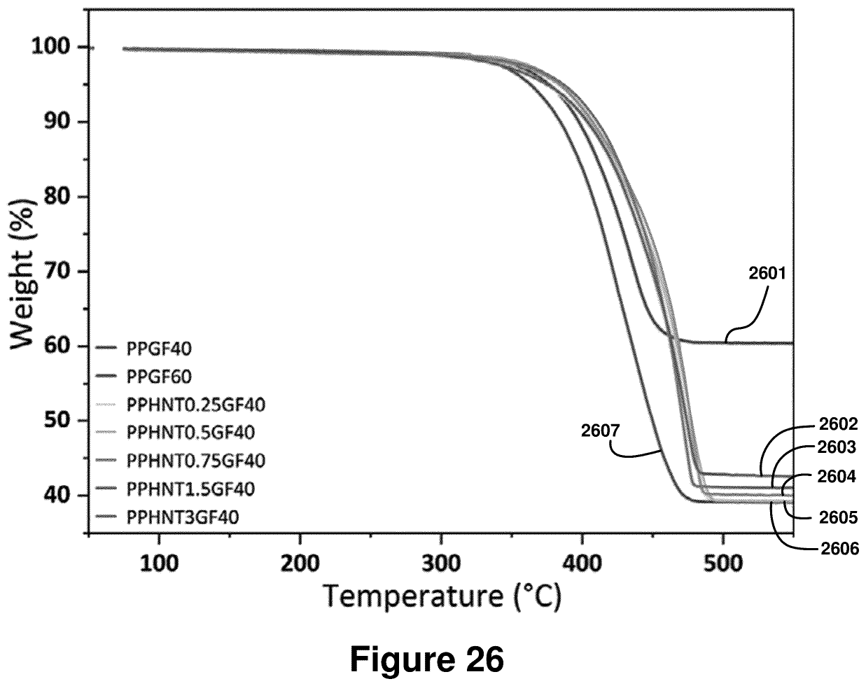

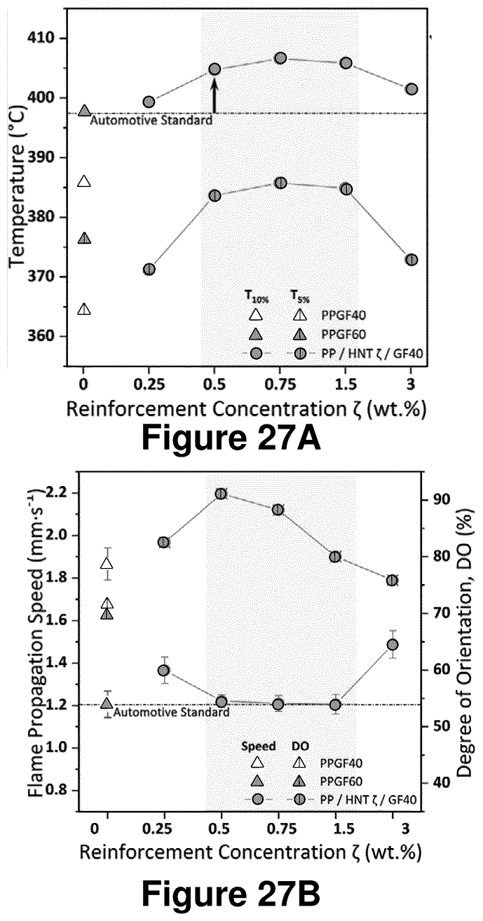

FIG. 22A is a graph of Thermal Conductivity with respect to reinforcement concentration for the fabricated composites. FIG. 23 is a graph of Heat Dissipation “Temperature with respect to Time” for select fabricated composites. FIG. 22B is a graph of the Temperature Difference between the Front and Back Surfaces of 3 mm-thick specimens. FIG. 24 show thermal Images for PPGF60 and FIG. 25 show thermal photos of PPHNT0.5GF40, highlighting the thermal management performance of the hybrid composites; middle images are showing Tₘₐₓ values of front and back sides of the samples. FIG. 26 shows thermal decomposition profiles for select fabricated composites. PPGF40 is shown at 2607, PPGF60 is shown at 2601, PPHNT0.25GF40 is shown at 2606, PPHNT0.5GF40 is shown at 2605, PPHNT0.75GF40 is shown at 2604, PPHNT1.5GF40 is shown at 2603, and PPHNT3GF40 is shown at 2602. FIG. 27A is a graph of T₅% and T₁₀% with respect to reinforcement concentration for select fabricated composites. FIG. 27B is a graph of flame propagation speed and DO with respect to reinforcement concentration for select fabricated composites.

The bulk thermal conductivity of the fabricated composites was evaluated to highlight the degree of enhancement and synergistic effect induced by the cylindrical core-shell architecture in the hybrid composites, compared to that of their biphasic counterparts, as shown in FIG. 22A. To validate the thermal management performance of the fabricated composites, PPGF60 was selected as a baseline, as it is the automotive standard for structural components, regardless of its limited functionalities. For the biphasic PP/HNT composites, the introduction of HNTs slightly decreases the bulk thermal conductivity, due to the phonon scattering effect at the nano-filler/matrix interphase, imparted by the relatively-well dispersed HNTs that are incapable of effectively forming thermal conductive pathways to facilitate phonon transport, at these low concentrations. Further increasing the concentration beyond 0.5 wt % HNT, imparts negligible change to the bulk thermal conductivity, as the phonon scattering effect is not suppressed due to significant HNT agglomeration, which enhances scattering at the filler/matrix interphase. On the contrary, for the biphasic PP/GF composites, the bulk thermal conductivity increases proportionally with increasing GF concentration. Considering the thermal conductivity coefficients for Neat PP (22.4 cW m⁻¹ K⁻¹), E-type GFs (100 cW m⁻¹ K⁻¹), and HNTs (10 cW m⁻¹ K⁻¹) in the biphasic composites, the GFs function as anisotropic thermally conductive fillers, while the HNTs impart insulating characteristics relative to the Neat PP. Specifically, the biphasic PP/GF composites exhibit the highest thermal conductivity in the fiber orientation direction (in-plane), with significantly lower thermal conductivity in the perpendicular direction (through-plane). For the hybrid PP/HNT/GF composites, the bulk thermal conductivity is lower than that of the biphasic PP/GF composites, reaching a minimum in PPHNT0.5GF40 (25.9 cW m⁻¹ K⁻¹), whereby the bulk thermal insulation characteristics increased by ≈18%, compared to PPGF60 (31.7 cW m⁻¹ K⁻¹), demonstrating a clear SE % of 36%. This behavior can be attributed to the improved morphology of the hybrid composite, as per FIG. 13, whereby the DO increased significantly, compared to the biphasic composites. Hence, the lowest bulk thermal conductivity is present in the hybrid composite with the highest DO (PPHNT0.5GF40), as the reduced viscosity due to the addition of the HNTs favors reinforcement alignment in the melt flow direction. However, increasing the HNT concentration beyond this threshold will result in a bulk thermal conductivity increase, due to the lower DO, induced by the presence of HNT agglomerates.

To assess the influence of the hierarchical fibrous assembly on the thermal management performance (i.e., heat dissipation effectiveness) of the hybrid composites, a simple heat transfer experiment was conducted. First, the front surface of the sample was heated to 100° C., and then subsequently cooled to room temperature (30° C.), while continuously measuring the front and back surface temperatures (FIG. 23). Finally, the maximum temperature difference (ΔT_{HT}) between the front and back surfaces was determined, as shown in FIG. 22B. For the biphasic PP/GF composites, the ΔT_{HT} for PPGF40 and PPGF60 was determined to be 20.6 and 25.1° C., respectively. For the hybrid PP/HNT/GF composites, the greatest thermal management was observed for PPHNT0.5GF40 having a ΔT_{HT} of 36.6° C., which is an ≈46% improvement, compared to the automotive standard PPGF60. This behavior is attributed to the microstructural architecture alterations in the hybrid composite, as illustrated in FIG. 13, whereby the DO increased significantly, compared to the biphasic composites. Specifically, analyzing the micro-CT images, taken across the sample thickness (FIG. 15 and FIG. 16) of PPGF40 (lowest DO) and PPHNT0.5GF40 (highest DO), it is evident that even the GFs within the core region of the sample are highly oriented in the melt flow direction.

Generally, when conductive fibers are disordered (or entangled), a zigzagging heat path ensues, which impedes the rapid heat transfer through the material due to the extended tortuous pathways relative to the sample's length. This inevitable accumulation of heat within the sample, due to its slow dissipation, results in a greater temperature increase in the back of the sample (opposite to the heat source), leading to small ΔT_{HT}. Conversely, a higher DO facilitates an increase in the in-plane thermal conductivity, creating preferred anisotropic heat transport along the fiber orientation direction, thereby minimizing heat transfer in the through-plane direction. The difference in heat transport phenomena, between PPGF60 and PPHNT0.5GF40, is visually illustrated in the infrared-photographs presented in FIG. 24 and FIG. 25. This behavior is evident when examining the temperature over time (FIG. 23), as the front surface of the hybrid composites reached 100° C. significantly faster than the biphasic composites. This is attributed to the higher in-plane thermal conductivity resulting from an elevated DO for the hybrid composites. The preferential heat propagation in the in-plane direction minimizes heat transfer in the through-plane direction, thereby reducing heat transmission to the sample's back surface and consequently leading to a higher ΔT_{HT}. This feature is valuable in the automotive industry for protecting and prolonging the lifespan of critical components by preventing overheating.

Overall, the hybrid composites presented in this work containing an optimized cylindrical core-shell architecture, provide synergy-induced thermal management performance that biphasic composites are unable to achieve, due to their inability to ensure efficient heat dissipation, which stems from their relatively disordered fiber orientation producing inferior in-plane thermal conductivity. In fact, these composites were employed to fabricate battery casings with complex geometries for commercial electric vehicles, as detailed in Section S3: Prospective Application of the Supporting Information, demonstrating their viability for use in high-performance industrial applications with enhanced thermal management characteristics, improved processability and superior economic potential.

### 1.4 Thermal Stability and Flammability Performance

The thermal stability and flammability of the fabricated composites were evaluated to highlight the degree of enhancement and synergistic effect induced by the cylindrical core-shell architecture in the hybrid composites, compared to that of their biphasic counterparts, as shown in FIGS. 26, 27A, 27B To validate the thermal stability and flammability of the fabricated composites, PPGF60 was selected as a baseline, as it is the automotive standard for structural components, with stringent safety regulations, such as FMVSS 302 and SAE J369 for interior components. The thermal stability of the fabricated composites was assessed using TGA (FIG. 26). The characteristic weight loss temperatures obtained from the TGA curves are summarized in FIG. 27A, whereby the temperatures corresponding to 5% (T₅%) and 10% (T₁₀%) weight loss are key to understanding the decomposition onset of the PP matrix. Evaluating the hybrid PP/HNT/GF composites, the addition of various amounts of HNTs with a fixed GF concentration leads to an increase in T₅% and T₁₀%. Specifically, the hybrid composites reinforced with 0.5 to 1.5 wt % HNTs exhibited the highest T₅% and T₁₀% values of ≈384 and ≈405° C. respectively. Moreover, the T₅% and T₁₀% for PPHNT0.5GF40 increased by 8 and 12° C., respectively, compared to the automotive standard PPGF60, and increased by 19 and 20° C., respectively, compared to PPGF40.

This observed enhancement in the thermal stability of the hybrid composites can be related to the action of HNTs, which slow down the escape of volatile products during the degradation process. This effect is, in turn, attributed to the barrier and entrapment effects of HNTs. As documented in the literature, PP undergoes thermal degradation into volatile products above 250° C. in a nitrogen environment, due to random thermal scissions of the carbon chain bonds. In the initial degradation stage, volatile products may be entrapped within the HNTs' lumens, leading to an effective delay in mass transport and an increase in thermal stability. However, the hybrid composite with 3 wt % HNTs presents slightly lower T₅% and T₁₀% (372 and 401° C., respectively). This can be attributed to the presence of extensive agglomeration, causing discontinuities in the HNT concentration in the PP matrix. Consequently, this phenomenon affects the material's capability to trap volatile products throughout the degradation process. Additionally, the reduced surface area of HNTs in the composite, resulting from the presence of agglomerates, diminishes their ability to entrap volatile products.

The flammability of the fabricated composites was assessed by vertical flammability experiments, as shown in FIG. 27B. For the biphasic PP/GF composites, rapid and complete consumption, accompanied by extensive dripping from the specimens, were observed. This behavior aligns well with previous findings reported by Papageorgiou et al., for biphasic PP/GF composites and hybrid PP/GnP/GF composites. Furthermore, the introduction of HNTs did not result in a significant reduction in composite flammability, as no self-extinguishment was observed for the composites, and dripping occurred for all the samples. Considering this, the flammability of the composites was investigated based on the time taken for the flame to reach the clamp using the ASTM D3801 vertical flame test configuration. and the flame propagation speed was determined by considering the time to reach the clamp and the sample geometry. Upon examining the biphasic and hybrid composites with a fixed GF content, a decrease in flame propagation speed was detected for the hybrid composites. This phenomenon can be attributed to the barrier and entrapment effects of the HNTs, combined with their higher decomposition temperature. These factors may “dilute” and “cool down” the combustion products, thereby slowing down the release of flammable gases. For PPHNT0.5GF40, a propagation speed of 1.2 mm s⁻¹ was measured, which is comparable to the automotive standard PPGF60 with 1.2 mm s⁻¹, and lower than 1.9 mm s⁻¹, measured for PPGF40, thereby satisfying the flammability safety regulations for high-performance automotive applications.

### 2 Conclusion

This work showcases the development of a hybrid composite featuring a cylindrical core-shell architecture, inspired by strong and tough natural structures like compact bone and bamboo. The core of this reinforcement features HNTs electrostatically self-assembled along the surface of GFs which induce trans-crystals at the fiber/matrix interface, yielding the shell of the cylindrical core-shell architecture. This cylindrical core-shell structure exhibits a microscopic stiffness gradient along the fiber/matrix interface, as demonstrated in nanoindentation property mapping, with trans-crystallization enhancing interfacial stress transfer leading to enhanced bulk mechanical properties. The β-phase nucleation effect imparted by HNTs enables the matrix to absorb energy through strain-hardening mechanisms, leading to a tougher mechanical response. Thus, the hierarchical structuring resulted in a significant improvement of macroscopic mechanical properties, it achieved an 84% increase in impact strength, a 27% increase in specific tensile strength, a 56% increase in tensile toughness, and a 30% increase in specific flexural strength, coupled with a 20% weight reduction, which underscores its potential in structural applications. These improvements are attributed to both the crystalline microstructure and polymorphism modifications imparted by the HNTs, coupled with the ability of HNTs to increase the hybrid composite's DO, which imparts synergy in the composite's bulk properties.

Beyond these, we found that HNT incorporation lubricates the hybrid composite melt, behaving as rolling contact bearings that reduce internal friction, thereby increasing the DO of GFs as compared to highly viscous biphasic composites. This reduction in melt viscosity thereby mitigates injection system tool wear, while improving melt-flow throughput, overall processability, as well as mechanical performance. In the context of multifunctionality, heat dissipation experiments showed that the hybrid composites exhibit thermal anisotropy owing to their higher DO which minimizes heat transfer in the through-plane direction, reducing heat transmission to the sample's back surface. The presence of HNTs increased the thermal stability of the hybrid composites due to their high decomposition temperature, combined with the barrier and entrapment effects that retard the escape of volatile products during matrix degradation. This highlights the potential of this material as a thermal insulant and protective barrier.

In summary, the bio-inspired hybrid composites based on cylindrical core-shell architecture exhibit multi-scale reinforcement behaviors that not only improve mechanical performance, thermal stability and insulation ability but also act as an environmentally friendly processing aid in industrial-scale manufacturing systems. This unique combination of bulk properties presents a promising avenue for the development of high-performance, multifunctional materials with applications in various industries. In the frame of green manufacturing, this low-cost scale-able assembly strategy is a significant advancement in overcoming existing industrial light-weighting challenges and can be used to circumvent material redundancies in larger systems.

### 3 Experimental Section

### 3.1 Materials and Sample Preparation

As-purchased Neat PP pellets (HIVAL® 2435, Nexeo Plastics, The Woodlands, United States) and 60 wt % long GF-filled PP pellets (LE1G60, Kolon Industries, Daegu, South Korea) with a GF (length: ≈10 mm, diameter: 20 μm) were used to prepare all polymer composites in this work. HNTs (Sigma Aldrich, Massachusetts, United States) were also used as a reinforcing phase in composites. Prior to use, the HNTs were dried under vacuum for 24 h at 110° C., to remove interlamellar-bound water.

To produce the 20 wt % PP/HNT masterbatch, HNTs (length: 1-3 μm, diameter: 30-70 nm, surface area: 64 m2 g⁻¹, density: 2.53 (true specific gravity)) were mixed with Neat PP pellets and extruded using a twin-screw extruder with a linear temperature profile across the 10 heating zones, from 120° C. (feeding) to 190° C. (die). The extruded filaments were pelletized using a tabletop pelletizer (BT25, Scheer Bay Co., Michigan, United States) with an end-pellet size of ≈5 mm in length and ≈3 mm in diameter.

PP/HNT/GF composites with varying GF concentrations were prepared in 1 kg batches by diluting the PPGF60 masterbatch with the Neat PP and PPHNT20 pellets using dry blending, followed by extrusion using a Leistritz® twin-screw extruder (27 mm, L/D: 40; Nuremberg, Germany) to ensure thorough mixing of the nanomaterial. A screw speed of 45 rpm and an increasing linear temperature profile across the 10 heating zones from 140° C. (feeding) to 190° C. (die) were used for the extrusion process. The composite melt was then injection-molded using a 50-ton Arburg Allrounder™ 270/320C injection molding machine (Arburg: Lossburg, Germany) with a 30 mm diameter screw. The molten materials were injected into a custom dual tensile and flexural sample mold, maintained at 80° C. The end composites are of the geometry for ASTM D638-Type IV and ASTM D790 standard tests respectively. The following nomenclature was used: PPHNTζGF40, where ζ denote the weight fraction, in percent, of HNTs in the composite.

### 3.2 Microstructural Characterization

To measure the electrostatic interactions between the HNT and GFs, a Brookhaven Instruments Corporation ZetaPlus™ Zeta Potential Analyzer was used. The HNT-decorated GFs or undecorated GFs were dispersed in deionized water (pH ≈7) with analysis conducted using a red laser light source (660 nm wavelength).

To confirm the self-assembled architecture in the composites, the neck region of the tensile samples was cryogenically fractured, yielding fracture surfaces parallel to the melt flow direction during processing. Fractured samples were sputter-coated with platinum and analyzed using a Quanta™ 250 FEG scanning electron microscope (SEM; FEI Company, Oregon, United States) with an energy-dispersive X-ray (EDS) detector, under an accelerating voltage of 10 kV.

Non-isothermal differential scanning calorimetry (DSC) was used to evaluate the crystallization mechanism of the matrix in the prepared composites. calorimetric samples were cut consistently from the center of the non-tested tensile samples to a mass of 5-10 mg. These samples were cut and sealed in a DSC aluminum pan with an aluminum hermetic lid (TA Instruments, Delaware, United States). A DSC 250 (TA Instruments, Delaware, United States) was used for the analysis. Specimens were equilibrated at −50° C. followed by heating at a rate of 10° C. min⁻¹ to 250° C., for erasure of the material's previous thermal history of the samples. These specimens were then cooled at a rate of 10° C. min⁻¹ to −50° C., where they were held isothermally for 5 min to account for thermal lag. A second heating ramp was conducted at a rate of 10° C. min⁻¹, to 250° C. All tests were conducted under nitrogen atmosphere. The crystallinity of the composites was calculated from the DSC second heating curves according to Equation (1):

$${( {𝒳}_{c} )}_{DSC} = \frac{Δ {H}_{f}}{ϕΔ {H}_{0}} \times 100 \% \qquad ( 1 )$$

where ΔH_{f} is the measured enthalpy of fusion of the sample, ΔH₀ is the enthalpy of fusion for perfectly (100%) crystalline PP (ΔH₀=209 J·g⁻¹), and ϕ is the weight fraction of PP.

Crystal polymorphism and orientation of the injection molded composites were analyzed via X-ray diffraction (XRD), using a Rigaku Ultima IV Diffractometer (Cu K-α source with λ=1.54184 Å; Rigaku, Tokyo, Japan) with a diffracted beam monochromator and a scintillation counter. A scanning range (2θ) of 2° to 45° with a step size of 0.05° in reflection mode was selected for measurement. With the obtained 2θ and corresponding intensity values, the percentage of β crystalline phases ( [symbol] _{β}) of the composites was calculated from the XRD diffractogram using Equation (2):

$${𝒦}_{β} = \frac{{I}_{β ( 300 )}}{{I}_{β ( 300 )} + {I}_{α ( 110 )} + {I}_{α ( 040 )} + {I}_{α ( 130 )}} \times 100 \% \qquad ( 2 )$$

where I_{α(110)}, I_{α(040)}, and I_{α(130)} are the respective intensities of the (110), (040), and (130) diffraction peaks of the α-phase crystals and I_{β(300)} is the intensity of the (300) peak of the β-phase crystals.

Similarly, the total percent crystallinity of the composites, ( [symbol] _{c)DSC}, can be calculated according to Equation (3):

$${( {𝒳}_{c} )}_{XRD} = \frac{{I}_{c}}{{I}_{c} + {I}_{a}} \times 100 \% \qquad ( 3 )$$

where I_{c} and Iₐ are the intensities of the crystalline and amorphous peaks respectively.

Fast Scanning calorimetry (FSC) was used to support the XRD results and to provide insight on the effect of the HNT/GF assembly on the crystallization kinetics of the polymer matrix, including the nucleus geometry of the formed crystals. A Flash DSC 2+ calorimeter (Mettler Toledo, Ohio, United States) was used for the FSC analysis, coupled with UFS-1 calorimeter chips. Samples of PPHNT0.5GF40, PPHNT0.5, PPGF40 as well as Neat PP were prepared under a microscope with the inclusion of characteristic reinforcements in each specimen to ensure the FSC analysis correctly reflects the crystallization kinetics. Each sample was first subjected to heating at 220° C. for 0.1 s to remove prior thermal history, and was then cooled at the rate of 4000 K s⁻¹ to a specific isothermal crystallization temperature, followed by incremental isothermal hold durations between 0.01 and 100 s. After each isothermal crystallization treatment, the sample was quenched to −95° C. at 4000 K s⁻¹ to suppress further crystallization and preserve the isothermally-formed crystal structures. These samples were then heated to 220° C. at 1000 K s⁻¹ to study the melting endotherm of crystals formed during evolving isothermal durations from 0.01 to 100 s. This process was repeated for each selected isothermal crystallization temperatures, which are 50, 60, 70, 80, 90, 100, and 110° C., and then for each sample. The change in melting enthalpy was analyzed via the integration between the heat flow curve and a constructed sigmoidal baseline with respect to time for each reheating curve. PP displays rapid cold crystallization upon heating if not fully crystallized; Hence, the enthalpy of cold crystallization during each scan was subtracted from the total enthalpy of melting to isolate only the enthalpic contribution from the melting of isothermally formed crystals. By doing so for each reheating curve, the time evolution of melting enthalpy from 0.01 to 100 s of isothermal crystallization is obtained. The calculated enthalpy values as a function of time from the primary crystallization regime of each data set were normalized, linearized, and fitted to the Johnson-Mehl-Avrami-Kolmogorov (JMAK) equation to determine the magnitude of the Avrami index (n).

Polarized optical microscopy (POM) was used to visually illustrate the in situ crystallization of both PPHNTGF and PPGF composites. A BX53 Microscope (Olympus, Tokyo, Japan) with a heating stage, CSS450 (Linkam Scientific Instruments Ltd., Salfords, United Kingdom), was used. The sample was placed within the stage and was heated from room temperature at a rate of 20° C. min⁻¹ to 190° C. Samples were held isothermally at 190° C. for 3 min to melt the composite and were subsequently cooled at a rate of 30° C. min⁻¹ to 130° C. Specimens were then held isothermally at 130° C. for 10 min to allow for crystallization, with microscopic images obtained during this isothermal period.

To confirm the presence of a stiffer trans-crystalline phase in the PPHNTGF composites, topography imaging, and nanoindentation were carried out using a Hysitron™ TS 77 Select nanoindenter (Bruker, Massachusetts, United States) with a standard diamond Berkovich tip. For topography and gradient imaging, images with the size of 50 μm×50 μm were generated at a scanning rate of 1 Hz, a set point force of 4 μN, and a scan resolution of 256×256 pixels in scanning probe microscopy (SPM) mode. With the identified fiber reinforcement sites in SPM mode, nanoindentation was conducted for nanomechanical mapping. 14×14 indents with a 3-μm spacing in between were made on each identified site, generating a total of 196 successful indents with a load profile that consists of a 0.1667 s ramp to 1 mN, a 0.1667 s hold in 1 mN, and a 0.1667 s unload in load-controlled mode, and a serpentine piezo translation protocol.

To study the internal fiber orientation of the composites without disrupting the internal microstructure of injection molded samples, non-destructive micro-computed tomography (micro-CT) was conducted using an EasyTom 230 Micro-CT X-Ray System (RX Solutions, Chavanod, France). The tensile specimens were placed in the sample holder, and the neck region of the specimens were scanned at an accelerating voltage of 40 kV with a total scan time of 34 min. A total of 1847 projections were taken for each specimen, with 3D image reconstruction performed thereafter. The projections taken perpendicular to the melt flow direction during injection were used to quantify the degree of fiber orientation. From these images, 200 randomly selected glass fibers were selected per sample, and their tilt angles with respect to the injection flow direction were determined using the software 3D Slicer. These were then used to calculate the Hermans order parameters for each sample, as can be estimated from the following equation.

$$S = \frac{3 〈 {cos}^{2} θ 〉 - 1}{2} \qquad ( 4 )$$

$$where ,$$

$$〈 {cos}^{2} θ 〉 = \frac{{\sum }_{i = 1}^{200} {cos}^{2} {θ}_{i} sin {θ}_{i}}{{\sum }_{i = 1}^{200} sin {θ}_{i}} \qquad ( 5 )$$

and S=1 for perfectly oriented fibers.

The rheological behavior of the composites was characterized using a Rosand™ RH 2200 Rheometer with twin-bore (19 mm diameter) barrels (Bohlin Instrument, Cirencester, United Kingdom). Here the barrels were set to a temperature of 210° C. The cut tensile and flexural specimens were added to the hot barrels, and the barrels were allowed to reach a steady internal pressure of 0.6 MPa. The composites were then allowed to melt for 1.5 min, and the rheology measurement was conducted immediately by extruding the melt at varying shear rates of 600, 1000, 3000, 6000, and 10000 s⁻¹.

Using a simple MFI test, the rheological performance and processability of the composites could be quantified. Following the ASTM D1238 standard, the MFI was measured using a MFI2 Melt-Flow Indexer (Also known as an extrusion plastometer; Dynisco, Massachusetts, United States). Approximately 4 g of polymer or composite was allowed to melt at 230° C. for 3 min. A weight (2.16 kg) and piston were then placed with the die covered, and the polymer was left to melt for 2 more minutes to ensure complete melting, fully filling the barrel and eliminating voids that would act as melt discontinuities. The die cover was then removed, and the molten sample was allowed to achieve a steady flow before the polymer mass was collected, which was then normalized with the flow time. A minimum of 4 replicates for each composite composition were performed to ensure measurement repeatability, with average MFI values reported.

### 3.3 Mechanical Properties

For all mechanical tests, the samples were maintained at atmospheric conditions for a minimum of 48 h prior to testing. For each composition, at least 10 replicates were tested, with the mean average property values reported.

The tensile properties of the fabricated composites were evaluated in accordance with the ASTM D638 standard and was performed with an Instron 5965 Universal Testing System (Instron, Massachusetts, United States). A B-2 classification extensometer, gauge length of 25 mm, a load cell of 5 kN, and a crosshead speed of 5 mm min⁻¹ were used in accordance with this standard.

The Instron 5965 Universal Testing System was also used for the measurement of the flexural properties of the fabricated composites. During testing, a span length of 48 mm, a load cell of 5 kN, and a crosshead speed of 1.3 mm min⁻¹ were used, in accordance with the ASTM D790 standard.

The impact properties of the fabricated composites were measured using a Tinius Olsen™ IT504 plastics impact tester (Tinius Olsen), using unnotched samples, in accordance with the ASTM D4812 standard.

To quantify the synergistic effect of the hybrid architecture, the optimum effective synergistic effect

$$( {S}_{E}^{\%} )$$

was evaluated for tensile, flexural, and impact strengths, using the effective percent synergy equation:

$${S}_{E}^{\%} = \frac{k - ( p + q )}{( p + q )} \times 100 \% \qquad ( 6 )$$

where k is the magnitude of combined enhancement demonstrated by the hybrid composite with respect to the matrix and p and q are, respectively, the magnitudes of the enhancements contributed by the constituent reinforcements individually with respect to the matrix.

### 3.4 Thermal Conductivity and Heat Dissipation

Bulk thermal conductivity measurements were obtained for selected composites, with measurements conducted using injection-molded samples in the geometry of the ASTM D790 standard tensile testing specimen. A Hot Disk™ TPS2500S thermal constants analyzer (Hot Disk Instruments, Göteborg, Sweden) was used for the analysis. Here, a 7577 F1 Kapton-insulated sensor (Diameter: 2.001 mm) was used with tensile specimens covering the top and bottom surface of the sensor. Average thermal conductivity values were reported over triplicate measurements. Similar to the mechanical properties, the

$${S}_{E}^{\%}$$

in terms of bulk thermal insulation properties was evaluated using Equation (6).

The heat dissipation effectiveness of the composites was determined using a simple heat transfer experiment. First, the front surface of the injection molded tensile test specimen was heated to 100° C. via illumination from a SCHOTT light source with an intensity of 140 klx. The specimen was subsequently cooled to room temperature (30° C.), while simultaneously measuring the front and back surface temperatures using an infrared thermal camera (TOPDON, Model: TC002). The maximum temperature difference (ΔT_{HT}) between the front and back surfaces was calculated from this thermal camera.

The thermal stability of the composites was investigated using a Thermogravimetric Analyzer (TA Instruments, Delaware, United States) under a high-purity N₂ atmosphere, with a flow rate of 50 mL min⁻¹. Approximately 10 mg of each sample was placed in a platinum sample pan and subjected to heating from room temperature to 600° C. at a rate of 20° C. min⁻¹ while weight was continually recorded. The onset decomposition stage was evaluated from the temperature corresponding to 5 and 10 wt % weight loss.

In accordance with the ASTM D3801 standard, vertical flame tests were conducted on selected composites using injection-molded ASTM D790 standard flexural testing specimens. Here, each specimen was clamped to a stand and was approached by the test flame. Specimens were exposed to the test flame for 10 s at a separation distance of 10 mm. Since no self-extinguishing behavior was observed in the composites, and dripping was observed for all sample compositions, the time duration needed for the flame to propagate up the sample length and reach the clamp was reported. Additionally, the flame propagation speed was assessed by accounting for both the time needed for the flame to reach the clamp and the sample geometry.

### Supplementary Information

### S1: Morphology and Interfacial Interactions

### Zeta Potential Analysis

The electrostatic affinity between the reinforcing materials in this work were characterized using Zeta Potential measurements, shown in FIG. 28, highlighting the electrostatic charge of the un-sized GFs, sized GFs, and HNTs. The un-sized GFs have a negative electrostatic charge of −8 mV, the sized GFs have a positive electrostatic charge of +34 mV, induced by the aminosilane surface modification, and the HNTs have a negative electrostatic charge of −37 mV, due to isomorphic substitutions of aluminum (Al(III)) and silicon (Si(IV)) cations on the basal surface. It is evident that the HNTs and sized GFs have opposite charges, therefore, this facilitates their assembly under electrostatic interactions, creating a hierarchical interface. Beyond electrostatic interactions, the high shear and extensional deformation at elevated temperatures during the injection molding process combined with the volume exclusion effect induced by the GFs, physically constrains the motion of the HNTs within close proximity to the fibers' surface. This is believed to also foster their self-assembly to yield the hierarchically structured fiber assembly. FIG. 28 is a graph showing Zeta Potentials of the un-sized GF, sized GF, and HNT.

### X-Ray Photoelectron Spectroscopy (XPS)

X-ray photoelectron spectroscopy (XPS) was conducted on the sized GFs using a high-resolution Thermo Fisher Scientific K-Alpha™ to confirm the presence of aminosilane sizing, as shown in FIG. 29 for the sized GFs, as well as the un-sized GF. In the preparation of fibrous reinforcements for analysis, the initially received-sized GFs were extracted from the fabricated biphasic composite through a one-hour chemical etching process in boiling Xylene, aimed at removing the polypropylene (PP) matrix. The N1s peak in the sized GF spectra was deconvoluted, revealing protonated amino groups (˜398.9 eV) in the NH⁺/NH₂⁺ form and non-protonated amino groups (˜400.9 eV) in the NH/NH₂ form.^{[1-3]} The presence of protonated amino groups on the functionalized GF surface is attributed to the reaction between polar amino (NH/NH₂) groups from silane coupling agents and hydroxyl (OH) groups from both the GF surface and other silane molecules. FIG. 29 shows the XPS spectra of the sized GF: (a) Survey scan spectra, (b) Narrow scan spectra in the C1 s region, and (c) N1 s region.

### Scanning Electron Microscopy and Energy-Dispersive X-ray Spectroscopy

FIG. 30 depicts SEM images showcasing the GF surface uniformly and fully decorated with HNTs. This hierarchical fibrous assembly is illustrated in FIG. 30, at different magnifications, whereby it is evident that the HNTs completely encapsulate the GFs surfaces, mimicking the hierarchical architecture of biological systems.

FIG. 31 depicts SEM-EDS mapping showcasing the lack of aluminum signals along the GF surface in the biphasic PP/GF composite, compared to the hybrid composite.

The SEM-EDS mapping in FIG. 31 at A provides additional evidence of the preferential dispersion and arrangement of HNTs (aluminosilicates) on the GFs (mainly composed of silicon dioxide) within the PP matrix. This is highlighted by selectively emphasizing the alumina elemental phases. In contrast, the SEM-EDS mapping for the biphasic PP/GF composites, as depicted in FIG. 31 at B, does not reveal any aluminum phases due to the absence of HNTs in the composite. Furthermore, the higher intensities of oxygen and silicon elemental signals on the GF surface in the hybrid composites, as compared to the biphasic PP/GF composites, supports the successful formation of the hierarchically structured fibrous reinforcement.

FIG. 32 depicts SEM-EDS mapping showcasing. At A, FIG. 32 shows the uniform dispersion of HNTs in the 0.5 wt. % HNTs hybrid composite. At B, FIG. 32 shows the agglomeration of HNTs at 0.75 wt. % HNTs. Images with higher resolution can be accessed online.

In addition, the SEM-EDS mapping of PPHNT0.5GF40 in FIG. 32 at A shows the uniform dispersion of HNTs on both the GFs and within the PP matrix, showing no agglomerations that are aluminum-rich. On the contrary, the SEM-EDS mapping of PPHNT0.75GF40, as shown in FIG. 32 at B, revealed multiple agglomerates consisting of aluminum with sizes up to ˜40 μm. This confirms that above 0.5 wt. %, HNTs start to agglomerate in the hybrid composites and act as sites of stress concentration.

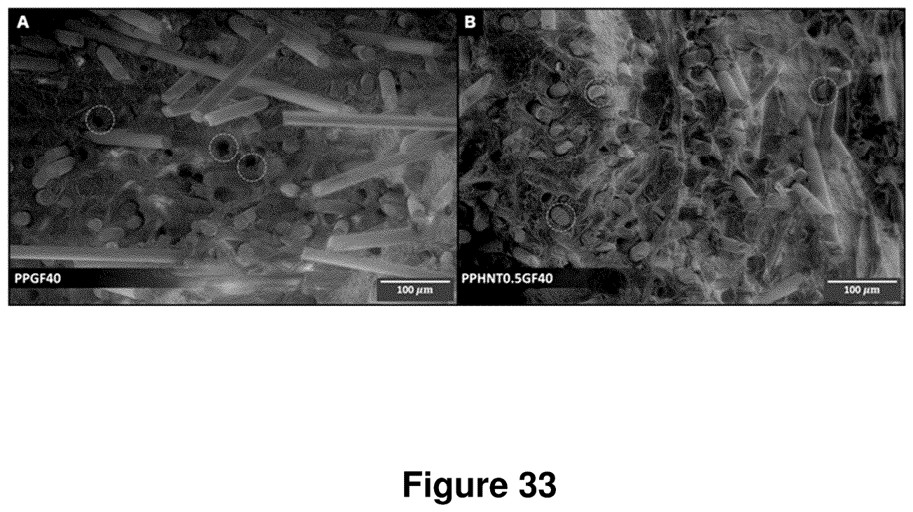

FIG. 33 shows SEM fractography analysis showcasing the failure mechanisms under uniaxial tensile for (A) biphasic and (B) hybrid composites.

### Nano-indentation Stiffness Mapping

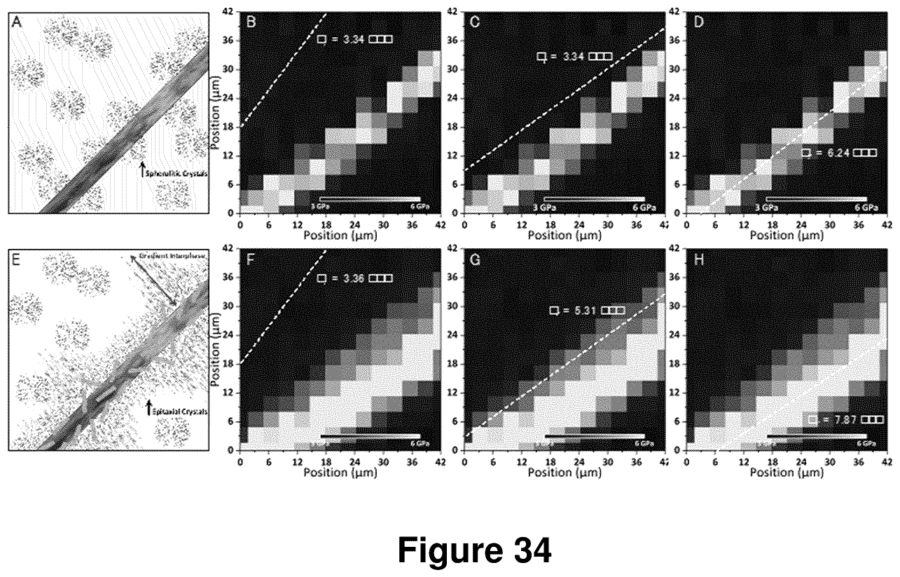

Nanoindentation mapping was employed to evaluate nano-scale stiffness variations in the proximity of biphasic composites and hybrid composites with cylindrical core-shell reinforcement, as shown in FIG. 34. In the biphasic PP/GF composite, only the presence of the predominant spherulitic α-form is observed, as depicted in the schematic of FIG. 34 at A. Analyzing the nanoindentation mapping in FIG. 34, B-D for the biphasic GF-reinforced composite, the average reduced modulus (Er) obtained from nanoindentations in the polymer matrix is 3.34±0.04 GPa. When considering the nanoindentation values at the GF/polymer matrix interface, the detected Eᵣ was 3.34±0.07 GPa, confirming the presence of the spherulitic α-form observed in the polymer matrix at the fiber/matrix interface. Furthermore, examining the Eᵣ over the GF embedded in the polymer matrix, the measured Eᵣ was 6.24±0.23 GPa. The significantly higher Eᵣ detected results from the presence of the high-stiffness GF. Profile lines were drawn at the matrix, at the fiber matrix interface, and over the fiber to illustrate the Eᵣ detected in these regions in FIG. 34 at B-D.

In contrast, for the hybrid PP/HNT/GF composites, the presence of the cylindrical core-shell reinforcement has led to the development of a gradient stiffness, ranging from the high-stiffness hierarchically structured fibrous reinforcement region to the low-stiffness PP matrix. This gradient is attributed to the existence of a stiffer interphase, constituting the shell in the cylindrical core-shell reinforcement, as depicted in the schematic of FIG. 34 at E. Analyzing the nanoindentation mapping in FIG. 34 at F-H for the hybrid composites, the nanoindentation values at the polymer matrix revealed an Eᵣ of 3.36±0.08 GPa, comparable to that obtained for the biphasic composite. This suggests the presence of the predominant spherulitic α-form in the matrix of the hybrid composite. Now, considering the fiber/matrix interphase (shell region), the obtained Eᵣ was 5.31 GPa±0.32 GPa, attributable to the presence of trans-crystals comprised in the shell region of the hybrid composite. Moreover, examining the Eᵣ over the hierarchically structured fibrous reinforcement portion embedded in the polymer matrix, the measured Eᵣ was 7.87±0.27 GPa. The significantly higher value detected in the hybrid composite compared to the biphasic material results from the combination of the high stiffness nanofiller electrostatically attached to the GFs and the presence of the trans-crystalline shell. This combination leads to a higher Eᵣ over the cylindrical core-shell reinforcement compared to the GF region in the biphasic composite. Profile lines were drawn at the matrix, at the fiber-matrix interface, and over the fiber to illustrate the Eᵣ detected in these regions in FIG. 34 at F-H.

FIG. 34: For the biphasic PP/GF composites: (A) Schematic representation of the crystalline microstructure, (B-D) Nano-indentation Eᵣ mapping. Similarly, for the Hybrid PP/HNT/GF composites: (E) Schematic representation of the crystalline microstructure, (F-H) Nano-indentation Eᵣ mapping.

### Micro-Computed Tomography (Micro-CT)

FIG. 35 displays selected tomography images captured across the thickness (mid-section) of the biphasic composites, which are reinforced with 40 and 60 wt. % of GFs. Additionally, FIG. 35 illustrates hybrid composites reinforced with 40 wt. % of GFs, with varying content of halloysite nanotubes (HNTs) ranging from 0.25 to 3 wt. %.

FIG. 35: Tomography images taken across the thickness (mid-section) of the biphasic and hybrid composites: (a) PPGF60, (b) PPGF40, (c) PPHNT0.25GF40, (d) PPHNT0.5GF40, (e) PPHNT0.75GF40, (f) PPHNT1.5GF40, and (g) PPHNT3.0GF40.

### S2: Mechanical Properties and Synergistic Effect

The mechanical properties of the fabricated composites were evaluated by uniaxial tension, three-point bending, and Izod impact tests, to highlight the degree of enhancement and synergistic effect induced by the hierarchically structured fiber-assembly in the hybrid composites, compared to that of their biphasic counterparts. The tensile and flexural modulus measurements are presented in FIG. 36. To validate the performance of the fabricated composites, PPGF60 was selected as a baseline for the mechanical properties and weight, as it is widely considered the standard for high-performance applications, such as structural automotive components.

FIG. 35: (A) Tensile Modulus, (B) Flexural Modulus, Effective Synergistic Effect for (C) Tensile and Flexural Modulus and (D) Tensile, Flexural, and Impact Strength with respect to reinforcement concentration for the fabricated hybrid composites.

### S3: Prospective Application

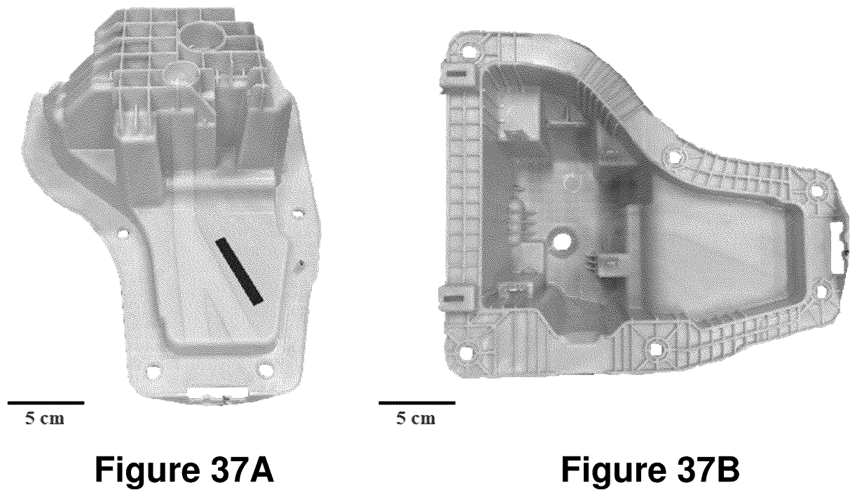

The hierarchical hybrid composites shown in this study offer mechanical properties enhanced through synergy, surpassing what biphasic composites can attain. This superiority arises from the hierarchical composites' capacity to establish a customized interphase with optimal interfacial interactions. The practical manifestation of these exceptional properties is underscored by the demonstrated applicability of these composites in real-world industrial settings. To illustrate, the advanced hybrid composite material (PPHNT0.5GF40) was utilized in the production of battery casings, featuring a complex geometry for a commercial electric vehicle. This process, depicted in FIG. 37, employed a 650-ton injection molding machine. FIG. 37 is a photograph of a battery casing manufactured from PPHNT0.5GF40, using a 650-ton injection molding machine, for an emerging commercial electric vehicle.

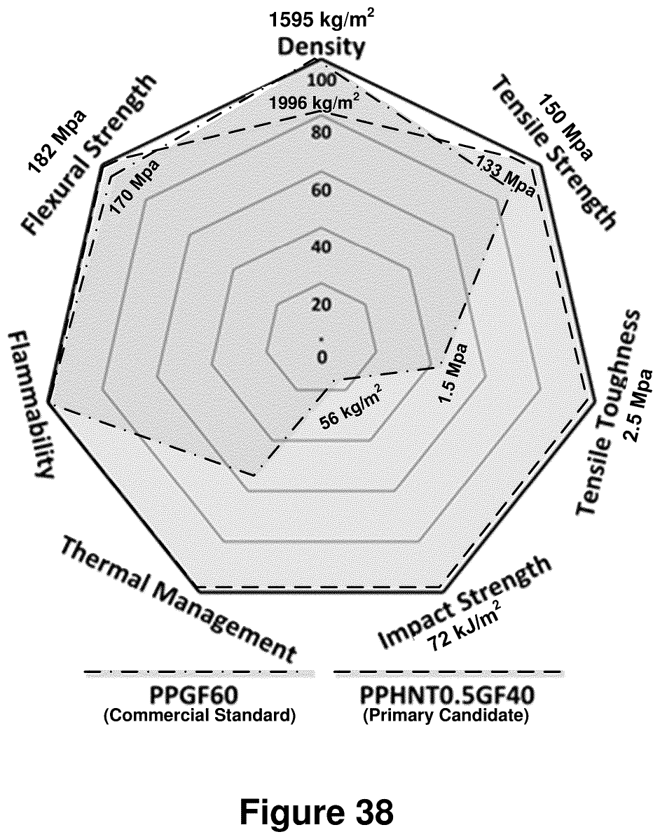

FIG. 38 is a schematic diagram for mechanical property comparison, highlighting the enhanced performance of hybrid composite PPHNT0.5GF40 versus automotive standard PPGF60, fabricated using different injection molding machines with varying geometries. FIG. 38 illustrates a comparison between the mechanical characteristics of the hybrid composite PPGnP0.5GF40 and the automotive industry standard PPGF60. The hybrid composite demonstrates superior performance in all mechanical aspects, except for composite stiffness, aligning with findings from conventional ASTM geometry samples produced using a 50-ton injection molding machine. This hybrid composite has proven to be a viable substitute for the previously utilized biphasic composite (PPGF60), allowing for substantial weight reduction without compromising mechanical strength. This, in turn, enhances the overall energy efficiency of the manufactured vehicle. In essence, the tailored nature of these hybrid composites has resulted in their practical application, contributing to industries meeting essential energy efficiency requirements for a more sustainable future.

What is claimed is:

1. A polymer composite comprising:
a plurality of fibrous assemblies, each fibrous assembly comprising a plurality of halloysite nanotubes deposited on a glass fiber with aminosilane surface modification; and
a polypropylene matrix forming trans-crystalline structures around the fibrous assemblies;
wherein the glass fibers comprise about 10% to 50% by weight of the polymer composite, and the halloysite nanotubes comprise 0.5±0.25% by weight of the polymer composite.

2. A polymer composite comprising:
a plurality of fibrous assemblies, each fibrous assembly comprising a plurality of halloysite nanotubes deposited on a glass fiber; and
a polypropylene matrix forming trans-crystalline structures around the fibrous assemblies.

3. The polymer composite of claim 2 wherein the glass fibers are modified to induce a positive electrostatic charge, and the fibrous assemblies are assembled by electrostatic adhesion between the positive electrostatic charge of the glass fibers and the negative electrostatic charge of the halloysite nanotubes.

4. The polymer composite of claim 3 wherein the glass fibers are modified by silanization.

5. The polymer composite of claim 4 wherein the glass fibers are modified with an aminosilane coupling agent.

6. The polymer composite of claim 2 wherein the glass fibers comprise about 10% to about 60% by weight of the polymer composite.

7. The polymer composite of claim 6 wherein the glass fibers comprise about 10% to about 50% by weight of the polymer composite.

8. The polymer composite of claim 7 wherein the glass fibers comprise about 10% to about 30% by weight of the polymer composite.

9. The polymer composite of claim 7 wherein the glass fibers comprise about 20% to about 30% by weight of the polymer composite.

10. The polymer composite of claim 2 wherein the halloysite nanotubes comprise about 0.25% to about 3% by weight of the polymer composite.

11. The polymer composite of claim 10 wherein the halloysite nanotubes comprise 0.5±0.25% by weight of the polymer composite.

12. The polymer composite of claim 11 wherein the halloysite nanotubes comprise 0.5±0.1% by weight of the polymer composite.

13. The polymer composite of claim 12 wherein the halloysite nanotubes comprise 0.5±0.025% by weight of the polymer composite.

14. The polymer composite of claim 2 wherein the trans-crystalline structures comprise β-crystals.

15. The polymer composite of claim 2 wherein the fibrous assemblies are substantially aligned.

16. An enclosure for an electrical component of a vehicle comprising the polymer composite of claim 2.
